(19) United States
(12) Patent Application Publication
(10) Pub. No.: US 2024/0158249 A1
(43) Pub. Date: May 16, 2024

(54) METHOD FOR PRODUCING INORGANIC SOLUTION, AND APPARATUS FOR PRODUCING INORGANIC SOLUTION

(71) Applicant: NATIONAL INSTITUTES FOR QUANTUM SCIENCE AND TECHNOLOGY, Chiba-shi, Chiba (JP)

(72) Inventors: Masaru Nakamichi, Chiba-shi (JP); Suguru Nakano, Chiba-shi (JP); Jaehwan Kim, Chiba-shi (JP); Taehyun Hwang, Chiba-shi (JP)

(21) Appl. No.: 18/281,158

(22) PCT Filed: Mar. 10, 2022
(86) PCT No.: PCT/JP2022/010643

§ 371 Date: Sep. 8, 2023

(30) Foreign Application Priority Data
Mar. 10, 2021 (JP) 2021-038661

(51) Int. Cl. C01F 3/02; C01D 15/02; C01D 15/08; C22B 1/24; C22B 3/10

(52) U.S. Cl. CPC C01F 3/02; C01D 15/02; C01D 15/08; C22B 1/24; C22B 3/10

(57) ABSTRACT

In order to provide a novel production method that produces a solution of an inorganic substance which is poorly soluble in both a basic solution and an acidic solution, and that is highly energy efficient, a method for producing an inorganic substance solution (BeCl₂ solution production method M10) includes: a heating step (S13) of dielectrically heating a powdery mixture to obtain a liquid mixture containing an inorganic substance, the powdery mixture having been obtained by mixing powder of the inorganic substance and hydroxide.

### TECHNICAL FIELD

The present invention relates to a production method and a production device for producing a solution of an inorganic substance.

### BACKGROUND ART

It is known that beryllium is contained in a Be—Si—O ore and a Be—Si—Al—O ore. Examples of the Be—Si—O ore encompass bertrandite and phenacite. Examples of the Be—Si—Al—O ore encompass beryl and chrysoberyl. Hereinafter, ores containing beryllium such as those described above are called beryllium ores. The beryllium ore is an example of beryllium oxide.

In order to produce any of beryllium, a compound containing beryllium, and an alloy containing beryllium, a beryllium ore is first dissolved in a solvent so that beryllium is extracted from the beryllium ore. However, it is not easy to dissolve the beryllium ore in the solvent. Although an acidic solution such as sulfuric acid is known as a solvent in which a beryllium ore is easily dissolved, the beryllium ore is difficult to be dissolved even in the acidic solution.

Non-patent Literature 1 states that subjecting a beryllium ore to a pre-treatment such as a sintering treatment or a melting treatment makes it possible to dissolve the beryllium ore in the solvent.

### CITATION LIST

### Non-Patent Literature

[Non-patent Literature 1]
“Beryllium”, [online], Wikipedia, [searched on Jun. 25, 2019], Internet <URL: https://en.wikipedia.org/wiki/Beryllium>

### SUMMARY OF INVENTION

### Technical Problem

However, the pre-treatment for making the beryllium ore soluble in the solvent requires quite large energy. According to the item “Production” in Non-patent Literature 1, the temperature at which the sintering treatment is carried out is, e.g., 770° C., and the temperature at which the melting treatment is carried out is, e.g., 1650° C.

An aspect of the present invention is accomplished in view of the above problem, and its object is to provide a method for producing a solution of an inorganic substance (e.g., a beryllium ore) that is poorly soluble in both a basic solution and an acidic solution, the method being novel and having high energy efficiency.

### Solution to Problem

In order to attain the object, a method for producing an inorganic substance solution in accordance with aspect 1 of the present invention includes: a heating step of dielectrically heating a powdery mixture to obtain a liquid mixture containing an inorganic substance, the powdery mixture having been obtained by mixing powder of the inorganic substance and hydroxide.

In order to attain the object, a device for producing an inorganic substance solution in accordance with aspect 6 of the present invention includes: a mixing section that mixes powder of an inorganic substance with hydroxide to obtain a powdery mixture of the inorganic substance and the hydroxide; a container that accommodates the powdery mixture; and an electromagnetic wave generator that generates an electromagnetic wave for dielectric heating.

### Advantageous Effects of Invention

According to an aspect of the present invention, it is possible to produce a solution of an inorganic substance (e.g., a beryllium ore) that is poorly soluble in both a basic solution and an acidic solution.

### BRIEF DESCRIPTION OF DRAWINGS

FIG. 1 is a flowchart illustrating a method in accordance with Embodiment 1 of the present invention for producing a beryllium solution.

FIG. 2 shows a flowchart illustrating a method for producing beryllium, a flowchart illustrating a method for producing beryllium hydroxide, and a flowchart illustrating a method for producing beryllium oxide, which are in accordance with Embodiments 2 to 4 of the present invention.

FIG. 3 shows a flowchart illustrating a method in accordance with Embodiment 5 of the present invention for separating titanium and lithium from each other.

FIG. 4 is a view schematically illustrating a dielectric heating device in accordance with Embodiment 6 of the present invention.

FIG. 5 is a perspective view of an isolator included in the dielectric heating device shown in FIG. 4.

FIG. 6 is a graph showing the temperature of a mixture of a beryllium ore and sodium hydroxide and the output of the electromagnetic wave generator in a case where the heating step is carried out with the dielectric heating device shown in FIG. 4.

FIG. 7 is a graph showing the temperature of sodium hydroxide and the output of the electromagnetic wave generator in a case where only the sodium hydroxide is dielectrically headed with the dielectric heating device shown in FIG. 4.

FIG. 8 is a graph showing the temperature of sodium carbonate and the output of the electromagnetic wave generator in a case where only the sodium carbonate is dielectrically headed with the dielectric heating device shown in FIG. 4.

FIG. 9 is a view schematically illustrating a beryllium solution production device included in a beryllium production system in accordance with Embodiment 7 of the present invention.

(a) of FIG. 10 is a view schematically illustrating a crystallizer, an anhydrization device, and an electrolyzing device included in the beryllium production system in accordance with Embodiment 7 of the present invention. (b) of FIG. 10 is a view schematically illustrating a variation of a crystallization treatment tank included in the crystallizer shown in (a) of FIG. 10. (c) of FIG. 10 is a view schematically illustrating a variation of a dryer included in the anhydrization device shown in (a) of FIG. 10.

(a) of FIG. 11 shows a flowchart illustrating a method in accordance with Embodiment 8 of the present invention for producing lithium hydroxide, and (b) of FIG. 11 shows a flowchart illustrating a method in accordance with Embodiment 9 of the present invention for producing lithium carbonate.

FIG. 12 shows a flowchart illustrating a method in accordance with Embodiment 10 of the present invention for producing lithium carbonate.

FIG. 13 shows a flowchart illustrating a method in accordance with Embodiment 11 of the present invention for producing lithium carbonate.

FIG. 14 shows a flowchart illustrating a method in accordance with Embodiment 12 of the present invention for producing lithium hydroxide.

FIG. 15 shows a flowchart illustrating a method in accordance with Embodiment 13 of the present invention for producing lithium carbonate.

FIG. 16 shows a flowchart illustrating a method in accordance with Embodiment 14 of the present invention for producing lithium hydroxide.

FIG. 17 shows a flowchart illustrating a method in accordance with Embodiment 15 of the present invention for producing a nickel compound.

FIG. 18 shows a flowchart illustrating a method in accordance with Embodiment 16 of the present invention for separating iron.

FIG. 19 is a graph showing the solubility of yttrium, lanthanum, cerium, neodymium, samarium, terbium, and dysprosium in monazite obtained in Example 9.

### DESCRIPTION OF EMBODIMENTS

### Embodiment 1

(Method for Producing Beryllium Solution)

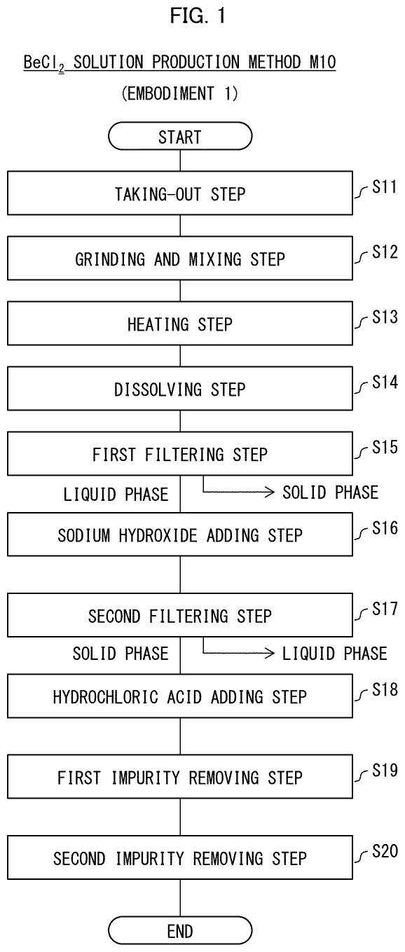

The following description will discuss a method M10 for producing a beryllium solution in accordance with Embodiment 1 of the present invention with reference to FIG. 1. FIG. 1 shows a flowchart of the method M10 for producing the beryllium solution. Hereinafter, the method M10 for producing the beryllium solution may also simply be referred to as a production method M10. The following description in the present embodiment will discuss a method for producing a BeCl₂ solution, which is an aqueous solution of beryllium chloride (BeCl₂) that is a hydrochloride of beryllium. The BeCl₂ solution is an example of the inorganic substance solution. Note that the beryllium solution to be produced by the production method M10 is not limited to the BeCl₂ solution, but may be a BeSO₄ solution, a Be(NO₃)₂ solution, a BeF₂ solution, a BeBr₂ solution, or a BeI₂ solution. The BeSO₄ solution is an aqueous solution of beryllium sulfate (BeSO₄), which is a sulfate of beryllium. The Be(NO₃)₂ solution is an aqueous solution of beryllium nitrate (Be(NO₃)₂), which is a nitrate of beryllium. The BeF₂ solution is an aqueous solution of beryllium fluoride (BeF₂), which is a hydrofluoric acid salt of beryllium. The BeBr₂ solution is an aqueous solution of beryllium bromide (BeBr₂), which is a hydrobromide of beryllium. The BeI₂ solution is an aqueous solution of beryllium iodide (BeI₂), which is a hydroiodide of beryllium.

In the present embodiment, a used tritium breeder material and a used neutron multiplying material are employed as the starting material used in the production method M10. Note, however, that the starting material used in the production method M10 is not limited to the used tritium breeder material and the used neutron multiplying material, and may be selected as appropriate from inorganic substances. Hereinafter, the inorganic substance is a generic term for inorganic compounds and metals. The inorganic compound refers to a compound other than an organic substance or an organic compound, that is, a compound that does not contain carbon. The inorganic compound preferably contains any of metals such as rare metals and rare earths described later. The metals include noble metals. The noble metals encompass gold (Au), silver (Ag), and platinum metals (ruthenium (Ru), rhodium (Rh), palladium (Pd), osmium (Os), iridium (Ir), and platinum (Pt)). There is a demand to recycle noble metals from used catalysts (e.g., motor vehicle exhaust catalysts) and waste batteries (e.g., fuel cells). The tritium breeder material and the neutron multiplying material are examples of the inorganic substances. More specifically, the tritium breeder material is an example of complex oxides, and the neutron multiplying material is an example of intermetallic compounds. The inorganic substance used as the starting material may be an inorganic substance that is industrially produced such as a tritium breeder material and a neutron multiplying material, or may be an inorganic substance that naturally occurs such as ores (described later).

For example, the production method M10 is suitable for a case where the starting material is an inorganic substance (such as a beryllium ore) that is poorly soluble in both a basic solution and an acidic solution. The beryllium ore is an ore containing beryllium, and a Be—Si—O ore and a Be—Si—Al—O ore are known. The beryllium ore is an example of silicate mineral. Examples of the Be—Si—O ore encompass bertrandite and phenacite. Examples of the Be—Si—Al—O ore encompass beryl and chrysoberyl. The beryllium ore is an example of beryllium oxide. In a case where the beryllium ore is employed as the starting material, for example, a BeCl₂ solution is obtained by carrying out the production method M10.

In the production method M10, it is possible to employ, as the starting material, an ore containing one or more kinds of metals. Examples of such an ore encompass, a lithium ore, dolomite, bauxite, magnetite, chromite, an iron ore, a cobalt ore, a sulfide ore, biochroa, molybdenite, sphalerite, barite, a tantalum ore, a ferromanganese ore, a PGM ore, rutile, silica stone, monazite, apatite, xenotime, and the like. The lithium ore is an example of a silicate mineral containing lithium (Li). As the lithium ore, spodumene (LiAlSi₂O₆) is known. The dolomite is an example of a carbonate mineral containing magnesium (Mg). The bauxite contains aluminum (Al) and gallium (Ga). The magnetite contains vanadium (V). The chromite contains chromium (Cr). The iron ore contains iron (Fe). The cobalt ore contains cobalt (Co). The sulfide ore contains nickel (Ni) and antimony (Sb). The biochroa contains niobium (Nb). The molybdenite contains molybdenum (Mo). The sphalerite contains indium (In). The barite contains barium (Ba). The tantalum ore contains tantalum (Ta). The ferromanganese ore contains tungsten (W). The Pt group metal (PGM) ore contains platinum (Pt) and palladium (Pd). The rutile is an aspect of crystal of titanium dioxide (TiO₂), and is a mineral having a tetragonal crystal structure. The silica stone is an ore name used in a case where silicate minerals and rocks are treated as resources. The main component of the silica stone is silicon dioxide (SiO₂). The monazite contains a rare earth element. The rare earth element is a generic term for scandium (Sc), yttrium (Y), and lanthanoid. Examples of the rare earth element contained in monazite encompass yttrium (Y), lanthanum (La), cerium (Ce), neodymium (Nd), samarium (Sm), europium (Eu), terbium (Tb), and dysprosium (Dy). The apatite contains calcium (Ca). The xenotime contains yttrium (Y). Each of monazite, apatite, and xenotime is an example of phosphate minerals.

The ore containing one or more kinds of metals is called a polymetallic nodule. As examples of the polymetallic nodule, a submarine hydrothermal deposit, a cobalt-rich crust, and a manganese nodule are known. The submarine hydrothermal deposits encompass, in addition to base metals such as copper, lead, and zinc, noble metals such as gold and silver and rare metals. The cobalt-rich crusts encompass rare metals such as nickel, cobalt, and platinum. The manganese nodules encompass base metals such as copper and rare metals such as nickel and cobalt.

In the production method M10, it is possible to use, as the starting material, mud containing one or more kinds of metals. As an example of the mud containing one or more kinds of metals, rare earth mud containing a rare earth element is known.

In the production method M10, it is possible to use, as the starting material, glass. As with silica stone, glass is an example of oxides containing silicon dioxide (SiO₂) as a main component. Such glass may contain a rare earth element as an additive. Other examples of the oxide encompass aluminum oxide (Al₂O₃) and magnesium oxide (MgO). The oxides also include complex oxides. The complex oxide refers to an oxide other than natural ores and contains, in addition to oxygen, multiple kinds of elements. Examples of the complex oxide encompass yttria stabilized zirconia (YSZ) and cordierite (2MgO·2Al₂O₃·5SiO₂). In the production method M10, it is possible to use, as the starting material, ceramics. Examples of the ceramics encompass alumina (Al₂O₃) and titania (TiO₂). The complex oxide such as yttria stabilized zirconia and cordierite is an example of ceramics.

In a case where any of these ores or mud is employed as the starting material and the production method M10 is carried out, for example, a hydrochloride solution of elements of the foregoing rare metal and rare earth is obtained.

In the production method M10, it is possible to use, as the starting material, a metal. Examples of the metal encompass the rare metals and rare earths described above. The starting material may be an alloy containing two or more kinds of these rare metals and rare earths. Examples of the metal other than rare earths encompass transition metals. Examples of the transition metal encompass titanium (Ti), chromium (Cr), iron (Fe), cobalt (Co), nickel (Ni), copper (Cu), and zinc (Zn). The starting material may be an alloy containing two or more kinds of metals among these transition metals. In many cases, a starting material made of such a transition metal is generated as scrap in a production step or a processing step of a machine, an electronic component, or the like. Such scrap may also contain dirty mud (called sludge) or dirty water. Sludge is generated as slag when a metal is smelted. A wide variety of metals may be contained in sludge, and an example of such metals is nickel. In a case where any of these metals is employed as the starting material and the production method M10 is carried out, for example, a hydrochloride solution of elements of the foregoing rare metal, rare earth, or transition metal is obtained. Thus, these metals can be recycled. In a case where nickel sludge is employed as the starting material and the production method M10 is carried out, it is possible to dissolve, in a hydrochloride solution, an element(s) (e.g., fluorine (F) and sulfur (S)) other than nickel contained in the nickel sludge. Thus, it is possible to heighten the purity of nickel in the nickel sludge.

As described above, the starting material in the production method M10 varies widely. In a case of expression with use of the Strunz classification, the starting material may be any of oxides, intermetallic compounds, silicate minerals, complex oxides, phosphate minerals, oxide minerals, double oxide minerals, sulfide minerals, tungstate minerals, and sulfate minerals.

As shown in FIG. 1, the production method M10 includes a taking-out step S11, a grinding and mixing step S12, a heating step S13, a dissolving step S14, a first filtering step S15, a sodium hydroxide adding step S16, a second filtering step S17, a hydrochloric acid adding step S18, a first impurity removing step S19, and a second impurity removing step S20.

(Taking-Out Step)

The taking-out step S11 is a step of taking out, from a blanket, a used tritium breeder material and a used neutron multiplying material with which the inside of the blanket of a nuclear fusion reactor is filled. In the production method M10, the used tritium breeder material and the used neutron multiplying material are used as a starting material.

Examples of the tritium breeder material encompass lithium oxide. Specific examples of the lithium oxide encompass lithium titanate (Li₂TiO₃), lithium oxide (Li₂O), lithium aluminate (LiAlO₂), and lithium silicate (Li₂SiO₃ and/or Li₄SiO₄). Examples of the neutron multiplying material encompass beryllium (Be) and intermetallic compounds containing beryllium (Be₁₂Ti and/or Be₁₂V, such compounds may also be referred to as beryllide). Each of the tritium breeder material and the neutron multiplying material is formed into a quite small spherical shape having a diameter of approximately 1 mm. The inside of the blanket is filled with the tritium breeder material and the neutron multiplying material mixed as uniform as possible. Thus, the starting material taken out from the blanket in the taking-out step S11 is a mixture of the tritium breeder material and the neutron multiplying material. The description in the present embodiment will discuss the production method M10 that uses (a) lithium titanate as an example of the tritium breeder material and (b) beryllium having a surface on which an oxidized layer is formed as an example of the neutron multiplying material. The tritium breeder material and/or the neutron multiplying material used as the starting material in the production method M10 are not limited to lithium titanate and beryllium, and may be selected as appropriate from the above-indicated examples.

Note that, even after beryllium is used as the neutron multiplying material, most part (e.g., approximately 98%) thereof is still beryllium. Thus, for the purpose of reducing the operating cost of the nuclear fusion reactor, it is strongly demanded to establish a technique for reusing beryllium, which is an expensive element, by turning beryllium into a beryllium solution. Meanwhile, used beryllium has a surface on which a layer of beryllium oxide (BeO) is formed. Therefore, merely by immersing the used beryllium in an acidic solution, beryllium contained in the used beryllium is hardly dissolved.

As described above, the starting material used in the production method M10 encompass at least any of (1) beryllium, (2) an intermetallic compound containing beryllium, (3) beryllium having a surface on which an oxidized layer is formed, and (4) an intermetallic compound having a surface on which an oxidized layer is formed and containing beryllium, each of which can function as a neutron multiplying material. The starting material used in the production method M10 may further contain lithium oxide that can function as a tritium breeder material.

The starting material used in the production method M10 is not limited to the neutron multiplying material and the tritium breeder material having been used in the nuclear fusion reactor. The starting material may be beryllium having been used in the atomic field other than the nuclear fusion field and the accelerator field and an alloy containing such beryllium, or may be beryllium generated as an industrial waste in general industrial fields and an alloy containing such beryllium. In accordance with the production method M10, it is possible to produce new beryllium by processing (1) a used neutron multiplying material and a used tritium breeder material generated in the nuclear fusion reactor, (2) a used neutron reflector generated in the atomic field other than the nuclear fusion field and the accelerator field, a used neutron moderator, beryllium and an alloy thereof contained in a used target material as a neutron source or the like, and (3) beryllium and an alloy thereof generated as an industrial waste in general industrial fields, without distinction between them. In addition, in accordance with the production method M10, it is possible to remove uranium, other element(s), and/or the like contained as impurities in the starting material.

(Grinding and Mixing Step)

The grinding and mixing step S12 is a step that is to be carried out after the taking-out step S11. In the grinding and mixing step S12, the starting material is ground first to obtain powder of the starting material. The grinding and mixing step is a step of grinding the starting material to reduce the particle diameter of the starting material and to mechanically break, even for a neutron multiplying material having a surface on which an oxidized layer is formed, the oxidized layer so that beryllium having been covered with the oxidized layer is exposed. The technique used to grind the starting material is not limited to any particular one, and may be selected from existing techniques as appropriate. Such a technique may be a technique involving use of a ball mill, for example.

In the grinding and mixing step S12, sodium hydroxide (NaOH) is ground to obtain powder of the sodium hydroxide. Note, however, that, in a case where powdery sodium hydroxide is purchased and used, the step of grinding sodium hydroxide in the grinding and mixing step S12 may be omitted. In a case where the sodium hydroxide used in the grinding and mixing step S12 is in the form of granules or flakes, it is possible to omit the grinding of the sodium hydroxide in the grinding and mixing step S12. The form of the sodium hydroxide used in the grinding and mixing step S12 is not limited. The sodium hydroxide is an example of hydroxides. The hydroxide used in the production method M10 is not limited to sodium hydroxide, and may be at least any of lithium hydroxide (LiOH), potassium hydroxide (KOH), calcium hydroxide (Ca(OH)₂), and strontium hydroxide (Sr(OH)₂).

Furthermore, in the grinding and mixing step S12, the powder of the starting material and the sodium hydroxide (in the present embodiment, the powder of the sodium hydroxide) are mixed together to obtain a powdery mixture of the starting material and the sodium hydroxide. Hereinafter, the powdery mixture of the starting material and the sodium hydroxide may be referred to simply as a powdery mixture.

(Heating Step S13)

The heating step S13 is a step of dielectrically heating the powdery mixture to fuse the starting material and the sodium hydroxide after the grinding and mixing step S12. By carrying out the heating step S13, the sodium hydroxide converts energy of an electromagnetic wave (described later) into heat, and consequently a liquid mixture containing the starting material and the sodium hydroxide is obtained. Hereinafter, the liquid mixture of the starting material and the sodium hydroxide may be referred to simply as a liquid mixture. The starting material and the sodium hydroxide do not contain moisture. Therefore, even in a case where the temperature of the powdery mixture or the liquid mixture exceeds 100° C., it is not necessary to consider boiling of the moisture. Thus, in the heating step S13, it is possible to dielectrically heat the powdery mixture under normal pressure. The liquid mixture obtained as a result of the heating step S13 is in the form of emulsion. As the temperature of the liquid mixture decreases, at least a part of the liquid mixture may change from emulsion to solid.

The dielectric heating is a generic term for techniques for applying, to a target object, an electromagnetic wave having a given frequency so as to heat the target object. According to the band of the electromagnetic wave to be applied, the dielectric heating is called radio-frequency heating or microwave heating. For example, the radio-frequency heating applies, to the target object, an electromagnetic wave (a so-called short wave or an ultrashort wave) within a band of not less than 3 MHz and less than 300 MHz, whereas the microwave heating applies, to the target object, an electromagnetic wave (a so-called microwave) within a band of not less than 300 MHz and less than 30 GHz. A microwave oven, which is widely used also in home, is an example of a device that can carry out the microwave heating.

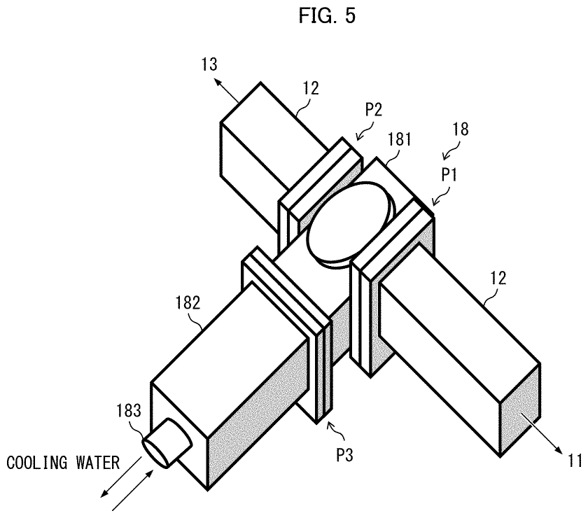

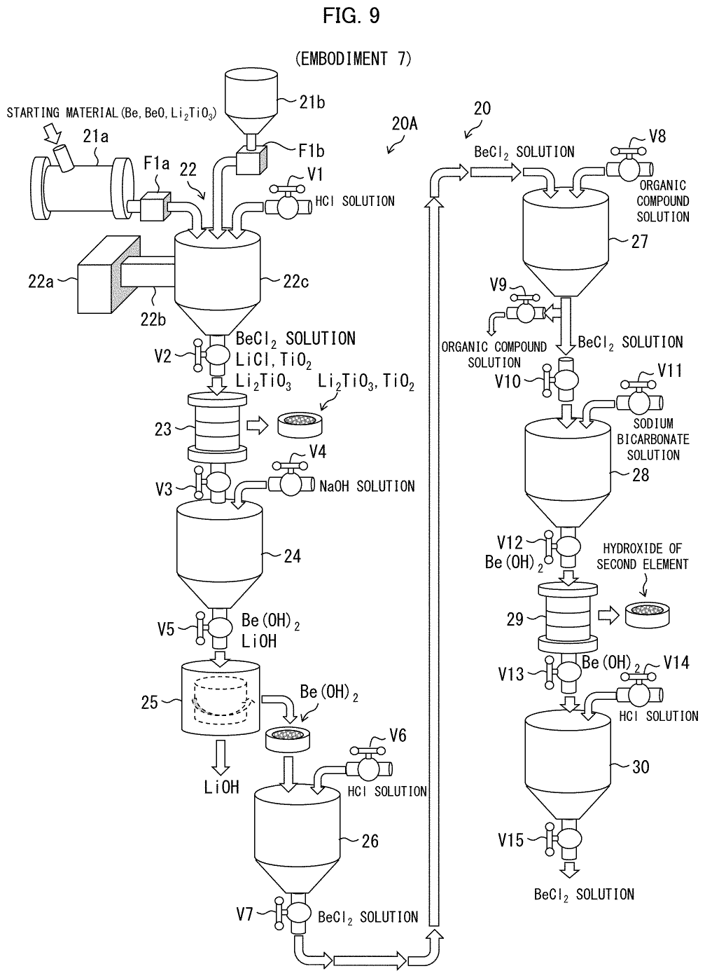

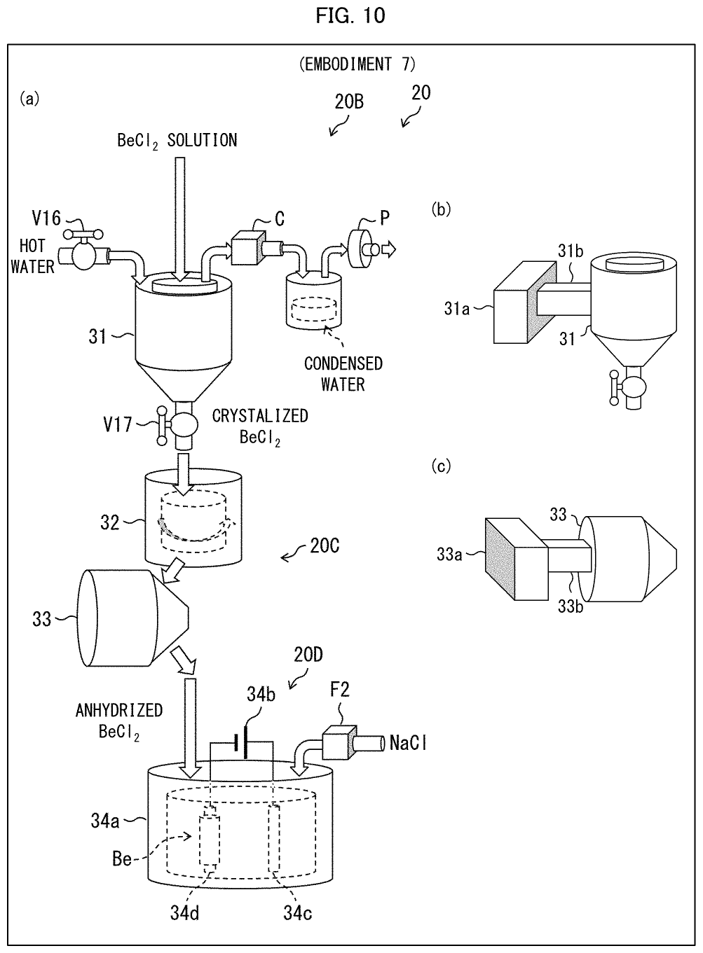

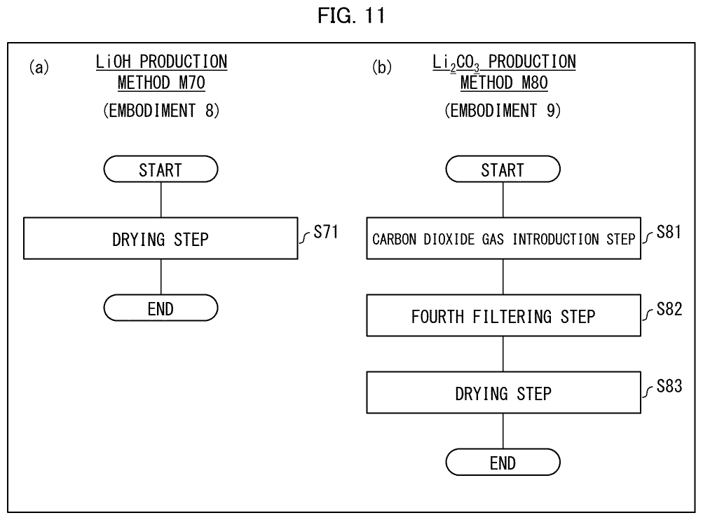

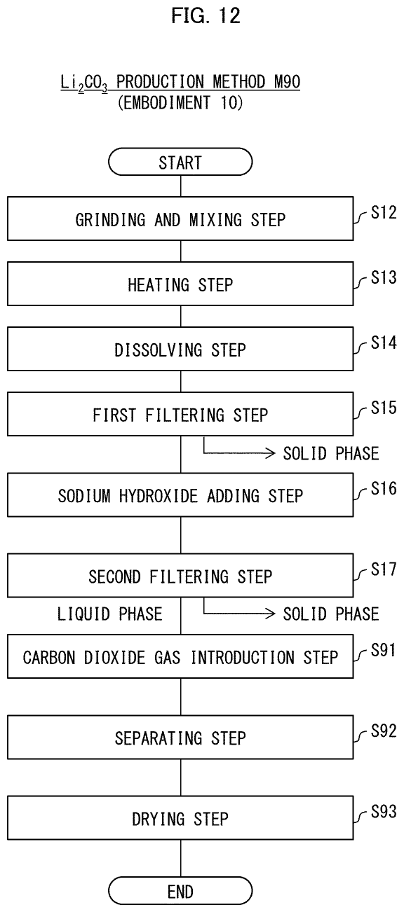

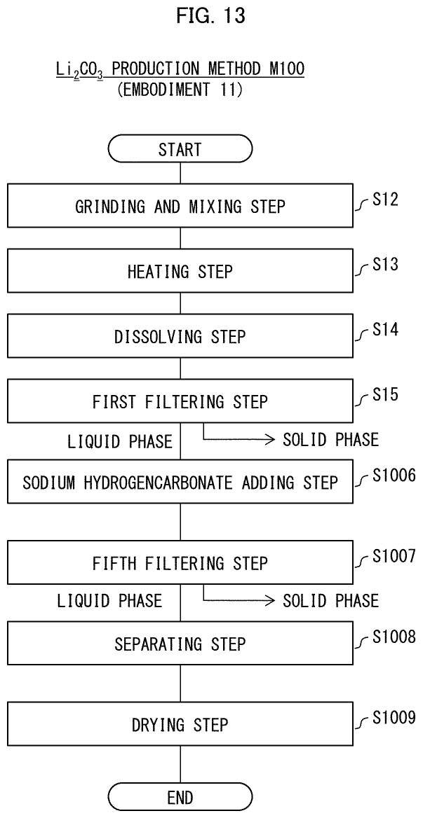

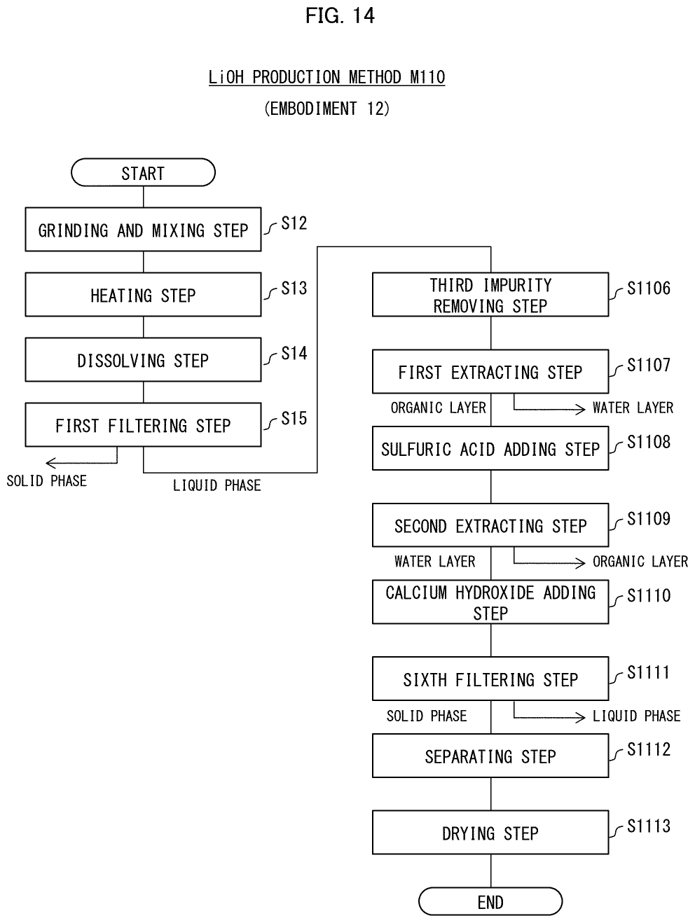

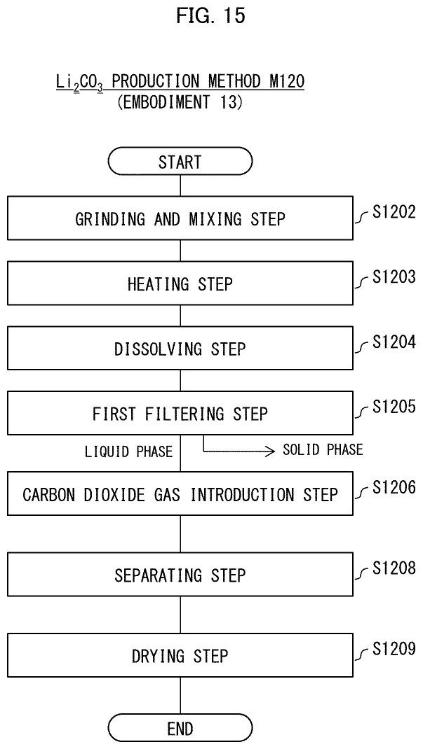

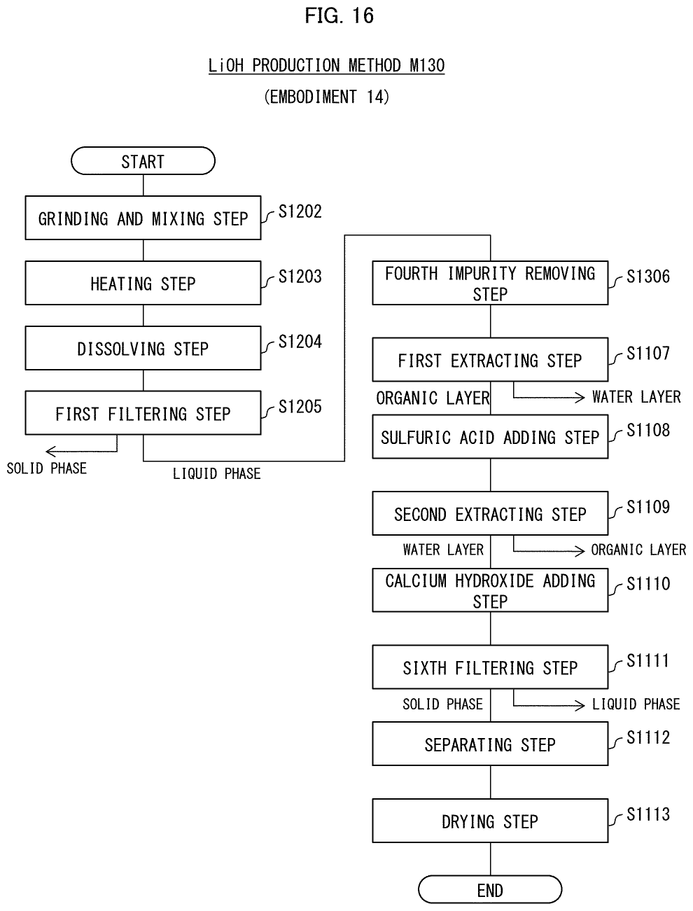

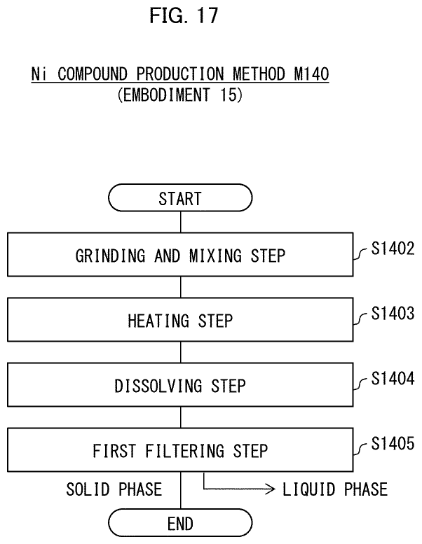

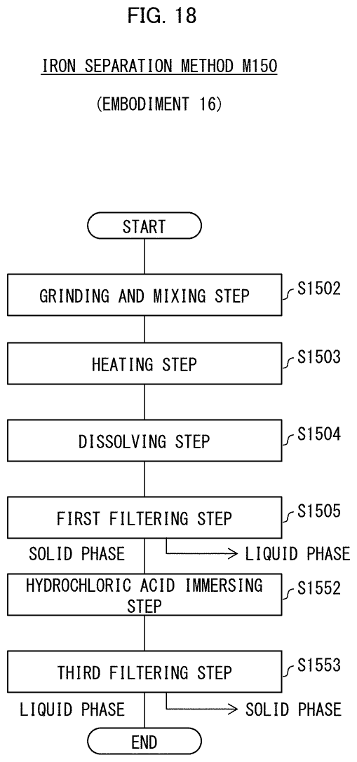

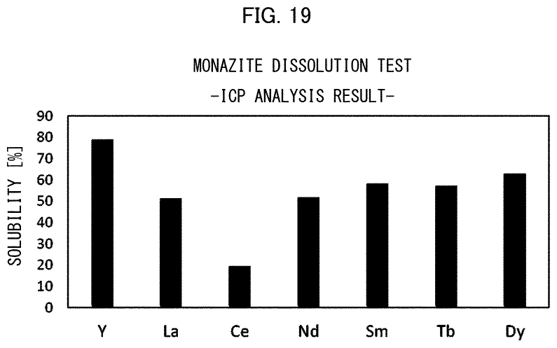

In the present embodiment, the heating step S13 applies, to the powdery mixture, an electromagnetic wave having a frequency of 2.45 GHz. The configuration of the device that applies an electromagnetic wave to the powdery mixture will be described later with reference to FIG. 5 or FIG. 9.

By heating the powdery mixture through the dielectric heating, it is possible to change the starting material and the sodium hydroxide into a liquid mixture that can be dissolved in an acidic solution with higher energy efficiency than conventional techniques. As described later, the liquid mixture is easily dissolved in an acid (in the present embodiment, hydrochloric acid) solution. Therefore, it is possible to yield a hydrochloric acidic solution in which beryllium chloride hydrate (BeCl₂·xH₂O) and lithium chloride (LiCl) are dissolved. Thus, the production method M10 can be provided as a novel production method with high energy efficiency.

A heating temperature in the heating step S13 can be set as appropriate. The heating temperature in the heating step S13 is preferably equal to or lower than a heatproof temperature of a container (e.g., a container 14 described in Embodiment 7) that accommodates the powdery mixture. For example, in a case where the container is made of polytetrafluoroethylene (e.g., the container 14), the heating temperature in the heating step S13 is preferably not higher than 250° C. The heating temperature may be 220° C., for example. In a case where the container is made of a material having corrosion resistance against the acidic solution and a heatproof temperature higher than 250° C., the heating temperature in the heating step S13 may be higher than 250° C. Examples of the material having a heatproof temperature higher than 250° C. encompass alumina (Al₂O₃) and boron nitride (BN). In a case where a container made of alumina, boron nitride, or the like is employed, the heating temperature in the heating step S13 may be higher than 250° C. The heating temperature in a case of using such a container may be 300° C., for example. It is highly probable that increasing the heating temperature in the heating step S13 will shorten the period of time taken for the heating step S13. A heating time in the heating step S13 can also be set as appropriate. The heating time may be for 8 minutes, for example.

In a variation of the heating step S13, it is possible to add a small amount of water to the powdery mixture before the powdery mixture is dielectrically heated. The water efficiently absorbs a microwave applied to the powdery mixture in the dielectric heating, and can convert the microwave to heat. Therefore, by adding a small amount of water to the powdery mixture, it is possible to increase the temperature of the powdery mixture quickly to a desired temperature (e.g., 250° C.). The amount of water to be added to the powdery mixture is not limited, and is preferably not less than 5 wt % on the basis of the mass of the powdery mixture.

(Dissolving Step)

The dissolving step S14 is a step that is carried out after the heating step S13. The dissolving step S14 is a step of dissolving the liquid mixture obtained in the heating step S13 in an acid (in the present embodiment, hydrochloric acid (HCl)) solution so as to obtain a hydrochloric acidic solution of a metal contained in the starting material. In the present embodiment, a hydrochloric acidic solution is obtained in which beryllium chloride hydrate (BeCl₂·xH₂O) and lithium chloride (LiCl) are dissolved. The acid solution used in the dissolving step S14 is not limited to the hydrochloric acidic solution. The acid solution may be at least one of a sulfuric acidic (H₂SO₄) solution, a nitric acidic solution, a hydrofluoric acidic solution, a hydrobromic acidic solution, a hydroiodic acidic solution. Alternatively, the acid solution may be a mixed acid solution that is obtained by mixing two or more acid solutions of these acid solutions. Examples of the mixed acid solution encompass aqua regia, which is obtained by mixing concentrated hydrochloric acid and concentrated nitric acid. In the dissolving step S14, it is possible to use water as a liquid for dissolving the liquid mixture obtained in the heating step S13.

In the dissolving step S14, the liquid mixture is dissolved even in a hydrochloric acidic solution at normal temperature and under normal pressure. However, by increasing the temperature of the hydrochloric acidic solution, it is possible to promote the dissolution of the liquid mixture in the hydrochloric acidic solution. A suitable way to heat the hydrochloric acidic solution is a device that applies an electromagnetic wave used in the heating step S13. In the dissolving step S14, it is preferable to set the temperature of the hydrochloric acidic solution to be lower than 100° C. in order to reduce the boiling of the hydrochloric acidic solution. With that feature, pressurization of the hydrochloric acidic solution is not necessary, and it is possible to carry out the dissolving step S14 under normal pressure.

(First Filtering Step)

The first filtering step S15 is a step that is to be carried out after the dissolving step S14. The first filtering step S15 is a step of separating, with use of a filter, a solid phase and a liquid phase contained in the beryllium solution containing lithium from each other. The solid phase contains a part of the lithium titanate and a part of the titanium oxide. The liquid phase that is the acidic solution mainly contains beryllium chloride hydrate and lithium chloride.

By carrying out the first filtering step S15, it is possible to easily separate (a) the titanium oxide contained in the solid phase and (b) the beryllium chloride hydrate and the lithium chloride contained in the liquid phase from each other.

(Sodium Hydroxide Adding Step)

The sodium hydroxide adding step S16 is a step that is to be carried out after the first filtering step S15. The sodium hydroxide adding step S16 is a step of adjusting the polarity of the acidic solution from acidity to neutrality, and then to basicity, the acidic solution having been obtained as a result of separation carried out in the first filtering step S15, containing the beryllium chloride hydrate and the lithium chloride each of which is the liquid phase, and not containing the titanium oxide that is the solid phase.

In the present embodiment, the sodium hydroxide adding step S16 is defined to add an aqueous sodium hydroxide solution to the acidic solution having been obtained as a result of separation carried out in the first filtering step S15. As a result, the polarity of the solution separated in the first filtering step S15 is changed from acidity to neutrality (pH 7), and then to basicity. Consequently, the beryllium chloride hydrate contained in the solution is turned into beryllium hydroxide (Be(OH)₂), so as to be precipitated as a solid phase in the basic solution. Note that the lithium chloride is dissolved in the basic solution, and would not be precipitated. That is, even after the sodium hydroxide adding step S16 is carried out, the lithium chloride still exists as the lithium hydroxide in the liquid phase.

(Second Filtering Step)

The second filtering step S17 is a step that is to be carried out after the sodium hydroxide adding step S16. The second filtering step S17 is a step of separating, with use of a filter, the solid phase and the liquid phase contained in the basic solution obtained through the sodium hydroxide adding step S16 from each other. The solid phase contains the beryllium hydroxide, and the liquid phase contains the lithium hydroxide.

By carrying out the second filtering step S17, it is possible to easily separate the beryllium hydroxide contained in the solid phase and the lithium hydroxide contained in the liquid phase from each other.

(Hydrochloric Acid Adding Step)

The hydrochloric acid adding step S18 is a step that is to be carried out after the second filtering step S17. The hydrochloric acid adding step S18 is a step of adding an HCl solution to the beryllium hydroxide obtained through the second filtering step S17 so that beryllium is dissolved, as beryllium chloride hydrate, in an acidic solution again. The concentration of HCl in the HCl solution can be adjusted as appropriate. Preferably, the concentration of HCl in the HCl solution is adjusted to have a pH of not more than 1.

By carrying out the hydrochloric acid adding step S18, it is possible to obtain a hydrochloric acidic solution in which the beryllium chloride hydrate is dissolved (such a solution may also be referred to as a beryllium solution or a BeCl₂ solution).

(First Impurity Removing Step)

The first impurity removing step S19 is a step that is to be carried out after the hydrochloric acid adding step S18. The first impurity removing step S19 is a step of removing, with use of an organic compound that adsorbs a first element, the first element from the beryllium solution obtained through the hydrochloric acid adding step S18.

The first element to be removed in the first impurity removing step S19 varies depending on the organic compound used here. Examples of the organic compound that can be used in the first impurity removing step S19 encompass tri-n-octylphosphine oxide (TOPO), di-(2-ethylhexyl) phosphoric acid (D2EHPA), tri-n-butyl phosphate (TBP), and ethylenediaminetetraacetic acid (EDTA). Examples of a commercially-available organic compound that can be used in the first impurity removing step S19 encompass UTEVA (registered trademark) resin available from Eichrom Technologies.

TOPO can adsorb Al, Au, Co, Cr, Fe, Hf, Re, Ti, UO₂²⁺, V, Zr, rare earth elements, and actinoid elements. D2EHPA can adsorb U, Co, Ni, Mn, and the like. TBP can adsorb U, Th, and the like. EDTA and similar ones can adsorb Mg, Ca, Ba, Cu, Zn, Al, Mn, Fe, and the like. UTEVA (registered trademark) resin can adsorb U, Th, Pu, Am, and the like. These elements are examples of the first element.

Any of the organic compounds can be dissolved in an organic solvent (e.g., kerosene, cyclohexane, benzene). The HCl solution that has undergone the hydrochloric acid adding step S18 is mixed with the solution in which any of these organic compounds is dissolved (hereinafter, such a solution may also be referred to as an organic compound solution), and a resultant is stirred. Consequently, the organic compound adsorbs the first element.

In the first impurity removing step S19, the HCl solution with which the organic compound solution is to be mixed is preferably acidic, and preferably has a pH of not more than 2. With this configuration, it is possible to enhance the efficiency at which the organic compound adsorbs the first element, while avoiding a phenomenon that the organic compound adsorbs beryllium. Note that, as the property of the HCl solution becomes closer to neutrality, the efficiency at which the organic compound adsorbs beryllium increases and the efficiency at which the organic compound adsorbs the first element decreases.

In the present embodiment, the organic compound and the organic solvent used in the first impurity removing step S19 are TOPO and kerosene, respectively. However, the organic compound and the organic solvent are not limited to TOPO and kerosene, and can be selected as appropriate from among the combinations shown as examples above.

A mixture of the beryllium solution, which is an aqueous solution, obtained through the hydrochloric acid adding step S18 and the organic compound solution is separated into two layers after being left for a while. Thus, the beryllium solution in which the content of the first element has been reduced as a result of the first impurity removing step S19 and the organic compound solution containing the first element can easily be separated from each other.

By carrying out the first impurity removing step S19, it is possible to reduce the concentration of the first element in the beryllium solution. Consequently, even in a case where, in a process for dissolving a starting material in an acidic solution so as to produce a beryllium solution, the starting material contains a first element that is an element other than beryllium such as those described above, it is possible to reduce the concentration of the first element in the beryllium solution used to produce any of beryllium, beryllium hydroxide, and beryllium oxide. Examples of the first element encompass uranium, thorium, plutonium, and americium.

Specifically, for example, in a case where beryllium is produced with use of beryllium chloride obtained by the production method M10 including the first impurity removing step S19, it is possible to reduce the concentration of uranium in beryllium so as to be less than 0.7 ppm. Even after being used as a neutron multiplying material in a nuclear fusion reactor, beryllium containing uranium at a concentration of less than 0.7 ppm exhibits a uranium concentration lower than a threshold that determines whether shallow-land disposal is allowed. Thus, beryllium encompassed in an aspect of the present invention can be subjected to shallow-land disposal without any treatment even after being used as a neutron multiplying material in a nuclear fusion reactor.

(Second Impurity Removing Step)

The second impurity removing step S20 is a step that is to be carried out after the first impurity removing step S19 and that adjusts the polarity of the beryllium solution from acidity to neutrality, and then to basicity so as to remove a second element from the beryllium solution, the beryllium solution having been obtained through the hydrochloric acid adding step S18. In the description in the present embodiment, the first impurity removing step S19 and the second impurity removing step S20 are carried out in this order after the hydrochloric acid adding step S18. Alternatively, the order of the first impurity removing step S19 and the second impurity removing step S20 can be changed.

In the present embodiment, the second impurity removing step S20 adds, to the beryllium solution that has undergone the hydrochloric acid adding step S18, sodium bicarbonate (NaHCO₃) until sodium bicarbonate is saturated. Consequently, after the polarity of the beryllium solution is changed to exceed neutrality (pH 7), an element(s) (e.g., Al and/or Fe) other than beryllium is/are turned into hydroxide(s) (e.g., Al(OH)₃ and/or Fe(OH)₃) so as to be precipitated in the beryllium solution. Even in a state in which sodium bicarbonate is saturated, Be(OH)₂ is dissolved in the beryllium solution and would not be precipitated. As described above, aluminum (Al) and iron (Fe) are examples of the second element.

The hydroxide(s) of the element(s) other than beryllium precipitated in the beryllium solution as a result of the second impurity removing step S20 can easily be removed from the beryllium solution by filtering the beryllium solution.

It is preferable to add HCl again to the beryllium solution from which the second element has been removed as a result of the second impurity removing step S20. By adding HCl again to the beryllium solution, the polarity of the Be(OH)₂ solution is adjusted to neutrality, and then to acidity. Consequently, in the solution, a highly pure beryllium chloride hydrate (BeCl₂·xH₂O) is generated.

By carrying out the second impurity removing step S20, it is possible to reduce the concentration of the second element in the beryllium solution. Consequently, even in a case where, in a process for dissolving a starting material in an acidic solution so as to produce a beryllium solution, the starting material contains a second element that is an element other than beryllium such as those described above, it is possible to reduce the concentration of the second element in the beryllium solution used to produce any of beryllium, beryllium hydroxide, and beryllium oxide.

As described above, in the production method M10, the heating step S13 preferably dielectrically heats the acidic solution containing beryllium oxide by applying a microwave to the acidic solution.

In a case where the production method M10 includes the pre-heating step, it is preferable that, similarly to the heating step S13, the pre-heating step dielectrically heat the basic solution containing the beryllium oxide by applying a microwave to the basic solution.

The technique of the dielectric heating involving use of a microwave (i.e., microwave dielectric heating) is a technique used for so-called microwave ovens, that is, a widely-used technique. Therefore, the production method M10 can reduce the cost of carrying out the production method M10, as compared to conventional production methods.

As described above, in the production method M10, the beryllium solution is preferably a beryllium chloride solution.

With the production method M10, it is possible to easily produce the beryllium chloride solution while skipping the phase of beryllium hydroxide. From the beryllium chloride solution, it is possible to easily produce beryllium, beryllium hydroxide, and beryllium oxide, as will be described later. Therefore, the beryllium chloride solution is suitable as the beryllium solution.

(Variation of Method for Producing Beryllium Solution)

As described above, the present embodiment has described the production method M10 in which the used tritium breeder material and the used neutron multiplying material are used as the starting material. The following description will briefly discuss the production method M10 in which, in this variation, beryl is used as the starting material. The beryl is an aspect of a Be—Si—Al—O-based beryllium ore, and is an example of the inorganic substance. That is, the beryl contains silicon (Si) and aluminum (Al), in addition to beryllium. The starting material may contain an ore other than beryl (e.g., spodumene (described later)).

In this variation, beryl obtained from a mine is used as the starting material. Therefore, the taking-out step S11 can be omitted.

In the grinding and mixing step S12, the beryl is ground to obtain powder of the beryl. Similarly, the sodium hydroxide is ground to obtain powder of the sodium hydroxide. Furthermore, the powder of the beryl and the powder of the sodium hydroxide are mixed together to obtain a powdery mixture of the beryl and the sodium hydroxide. In this variation also, the form of the sodium hydroxide is not limited to powder.

The heating step S13 and the dissolving step S14 are as described above with reference to FIG. 1. In the heating step S13, the dielectric heating is carried out so that the temperature of the mixture is 220° C., and the heating time is set to 8 minutes. The liquid mixture obtained as a result of the heating step S13 is in the form of a white-turbid emulsion.

The melting point of the beryl is 1410° C., and the melting point of the sodium hydroxide is 318° C. Therefore, the heating temperature in the heating step S13 is a lower temperature as compared to these melting points. Nevertheless, the beryl and the sodium hydroxide are fused, probably due to the fusion promoting effect associated with the application of an electromagnetic wave. In the production method M10, the beryl and the sodium hydroxide that are in the form of powder are mixed together. Therefore, the electromagnetic wave applied directly acts on the inside of the powdery mixture, and can directly heat the inside of the powdery mixture. Inside the powdery mixture, it is expected that electric discharge is caused by the application of an electromagnetic wave, and this electric discharge seems also to promote the fusion. As a result, in the production method M10, it is possible to change the beryl into a state that can be dissolved in the hydrochloric acidic solution despite the temperature as low as 220° C. In the technique disclosed in Non-patent Literature 1, for example, beryl is melted at a high temperature of approximately 2000° C. When compared to this technique, the production method M10 can reduce the energy consumption to approximately 1/10000 (0.01%).

Even after the heating step S13 and the dissolving step S14 are carried out, silicon contained in the beryl remains as a solid in the state of oxide in the hydrochloric acidic solution. Therefore, by carrying out the first filtering step S15, it is possible to remove the silicon from the beryllium chloride solution.

In a case where beryl is used as the starting material, the sodium hydroxide adding step S16, the second filtering step S17, and the hydrochloric acid adding step S18 can be omitted.

The first impurity removing step S19 and the second impurity removing step S20 are preferably carried out even in a case where beryl is used as the starting material. By carrying out the first impurity removing step S19, it is possible to reduce the concentration of the first element (e.g., uranium, thorium, plutonium, americium) contained in the beryllium chloride solution. By carrying out the second impurity removing step S20, it is possible to reduce the concentration of the second element (e.g., aluminum, iron) in the beryllium chloride solution. The beryl contains aluminum. However, by carrying out the second impurity removing step S20, it is possible to reliably remove the aluminum from the beryllium chloride solution.

By carrying out this variation as described above, it is possible to easily produce, while using beryl as a starting material, a beryllium chloride solution (which is an example of the inorganic substance solution) while skipping the phase of beryllium hydroxide.

(Method for Producing Lithium Solution)

In the above-described variation of the beryllium solution production method, beryl is used as the starting material, and a hydrochloric acidic solution is obtained in which beryllium chloride hydrate (BeCl₂·xH₂O) is dissolved. Next, the following description will briefly discuss a case where, with use of a lithium ore as the starting material, a hydrochloric acidic solution is obtained in which lithium chloride (LiCl), which is hydrochloride of lithium, is dissolved. In this production method, the starting material is changed from beryl to a lithium ore in the above-described variation of the beryllium solution production method. Therefore, this production method can be said a variation of the beryllium solution production method.

The following description will discuss a method for producing a LiCl solution, which is an aqueous solution of the lithium chloride (LiCl) that is hydrochloride of lithium. The LiCl solution is an example of the inorganic substance solution. However, the lithium solution to be produced by this production method is not limited to the LiCl solution, but may be a Li₂SO₄ solution, a LiNO₃ solution, lithium fluoride (LiF), lithium bromide (LiBr), or lithium iodide (LiI). The Li₂SO₄ solution is an aqueous solution of lithium sulfate (Li₂SO₄), which is a sulfate of lithium. The LiNO₃ solution is an aqueous solution of the lithium nitrate (LiNO₃), which is nitrate of lithium. Lithium fluoride (LiF) is a hydrofluoric acid salt of lithium. Lithium bromide (LiBr) is a hydrobromide of lithium. Lithium iodide (LiI) is a hydroiodide of lithium.

The lithium ore is a generic term for ores containing lithium, and is an example of the lithium oxide. The lithium ore has crystallinity. Examples of the lithium ore encompass spodumene (LiAlSi₂O₆), lepidolite (K(Al,Li)₂(Si,Al)₄O₁₀(OH,F)₂), petalite (LiAlSi₄O₁₀), and elbaite (Na(Li,Al)₃Al₆(BO₃)₃Si₆O₁₈(OH)₄). In this production method, spodumene, which is an aspect of the lithium ore, is used as an example of the starting material. In the conventional technique, a calcinating treatment at a temperature of not lower than 1000° C. is carried out to dissolve spodumene in a solution.

In the grinding and mixing step S12, the spodumene is ground to obtain powder of the spodumene. Similarly, the sodium hydroxide is ground to obtain powder of the sodium hydroxide. Furthermore, the powder of the spodumene and the powder of the sodium hydroxide are mixed together to obtain a powdery mixture of the beryl and the sodium hydroxide. In this variation also, the form of the sodium hydroxide is not limited to powder.

The heating step S13 and the dissolving step S14 are as described above with reference to FIG. 1.

Even after the heating step S13 and the dissolving step S14 are carried out, silicon contained in the spodumene remains as a solid in the state of oxide in the hydrochloric acidic solution. Therefore, by carrying out the first filtering step S15, it is possible to remove the silicon from the lithium solution.

In a case where spodumene is used as the starting material, the sodium hydroxide adding step S16, the second filtering step S17, and the hydrochloric acid adding step S18 can be omitted.

The first impurity removing step S19 and the second impurity removing step S20 are preferably carried out even in a case where spodumene is used as the starting material. By carrying out the first impurity removing step S19, it is possible to reduce the concentration of the first element (e.g., uranium, thorium, plutonium, americium) contained in the lithium solution. By carrying out the second impurity removing step S20, it is possible to reduce the concentration of the second element (e.g., aluminum, iron) in the lithium solution. The spodumene contains aluminum. However, by carrying out the second impurity removing step S20, it is possible to reliably remove the aluminum from the lithium solution.

### Embodiments 2 to 4

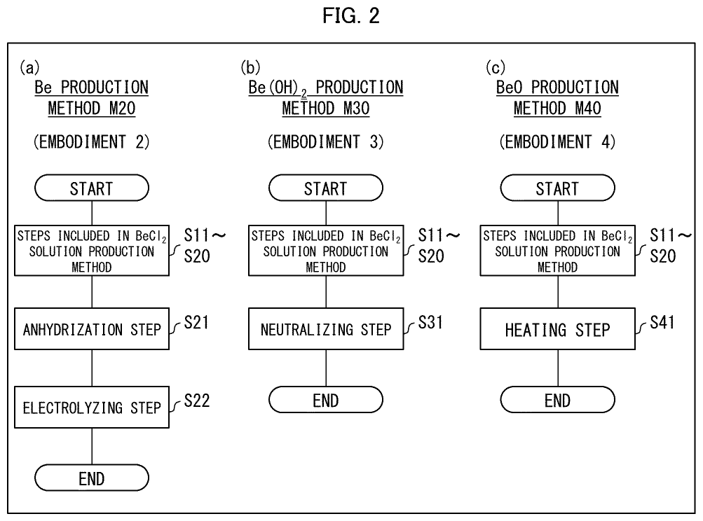

With reference to (a) to (c) of FIG. 2, the following description will discuss a method M20 for producing beryllium (Be), a method M30 for producing beryllium hydroxide (Be(OH)₂), and a method M40 for producing beryllium oxide (BeO) in accordance with Embodiments 2 to 4 of the present invention. (a) to (c) of FIG. 2 show a flowchart indicating the main part of the method M20 for producing beryllium, a flowchart of the main part of the method M30 for producing beryllium hydroxide, and a flowchart of the main part of the method M40 for producing beryllium oxide, respectively. Hereinafter, the method M20 for producing beryllium, the method M30 for producing beryllium hydroxide, and the method M40 for producing beryllium oxide may simply be referred to as the production method M20, the production method M30, and the production method M40, respectively.

(Method M20 for Producing Beryllium)

As shown in FIG. 2, the production method M20 includes the taking-out step S11, the grinding and mixing step S12, the heating step S13, the dissolving step S14, the first filtering step S15, the sodium hydroxide adding step S16, the second filtering step S17, the first impurity removing step S19, and the second impurity removing step S20 each of which is included in the production method M10 shown in FIG. 1, as well as an anhydrization step S21 and an electrolyzing step S22. Hereinafter, the taking-out step S11, the heating step S13, the first filtering step S15, the sodium hydroxide adding step S16, the second filtering step S17, the first impurity removing step S19, and the second impurity removing step S20 may also be referred to simply as the steps S11 to S20, respectively.

The steps S11 to S20 of the production method M10 that are included in the production method M20 are similar to the steps S11 to S20 described in Embodiment 1. Therefore, a description of the steps S11 to S20 is omitted here. That is, on the basis of an assumption that a BeCl₂ solution has been obtained by dissolving BeCl₂ in an HCl solution, the description of the production method M20 will deal with only the anhydrization step S21 and the electrolyzing step S22.

The anhydrization step S21 is a step of carrying out anhydrization of the beryllium chloride hydrate (BeCl₂·xH₂O) contained in the BeCl₂ solution obtained through steps S11 to S20 of the production method M10 so that BeCl₂, which is an example of beryllium salt, is generated.

The anhydrization step S21 adds ammonium chloride to the beryllium chloride hydrate, and heats the beryllium chloride hydrate in a vacuum at 90° C. for 24 hours. This can make the moisture content almost zero. That is, this can make the beryllium chloride hydrate anhydrous.

The ammonium chloride reacts with the moisture in the beryllium chloride hydrate, so as to be turned into ammonium hydroxide and hydrochloric acid. The ammonium hydroxide and the hydrochloric acid thus generated react with each other again, and are turned back into ammonium chloride while discharging water. As a result of the process carried out in this manner, it is possible to obtain beryllium chloride through anhydrization of the beryllium chloride hydrate.

The heating temperature in the anhydrization step S21 is not limited to 90° C., and may be selected as appropriate from a temperature range of not lower than 80° C. and not higher than 110° C. However, setting the heating temperature too high often causes insufficient anhydrization of the beryllium chloride hydrate. Therefore, the heating temperature is preferably not lower than 80° C. and not higher than 90° C., and more preferably is 90° C.

The period of time taken for the anhydrization treatment in the anhydrization step S21 is not limited to 24 hours, and may be set as appropriate.

The electrolyzing step S22 is a step of carrying out molten salt electrolysis of BeCl₂ obtained through the anhydrization step S21 so as to generate metal beryllium.

As described above, by carrying out the production method M20, it is possible to produce metal beryllium from a starting material.

(Method M30 for Producing Beryllium Hydroxide)

As shown in FIG. 2, the production method M30 includes the steps S11 to S20 of the production method M10 as well as a neutralizing step S31. As is the case with the production method M20, the description here will deal with only the neutralizing step S31.

The neutralizing step S31 is a step of neutralizing, with a base, BeCl₂·xH₂O contained in the BeCl₂ solution obtained through the steps S11 to S20 of the production method M10 so as to generate Be(OH)₂.

As described above, by carrying out the production method M30, it is possible to produce Be(OH)₂ from a starting material.

(Method M40 for Producing Beryllium Oxide)

As shown in FIG. 2, the production method M40 includes the steps S11 to S20 of the production method M10 as well as a heating step S41. As is the case with the production method M20, the description here will deal with only the heating step S41.

The heating step S41 is a third heating step of heating the BeCl₂ solution obtained through the steps S11 to S20 of the production method M10 so as to generate BeO. As a result of the third heating step, BeCl₂·xH₂O dissolved in the BeCl₂ solution is hydrolyzed to generate BeO.

As described above, by carrying out the production method M40, it is possible to produce BeO from a starting material.

(Conclusion)

In accordance with these production methods M20, M30, and M40, it is possible to produce beryllium, beryllium hydroxide, and beryllium oxide by a novel production method with high energy efficiency. Note that each of the anhydrization step S21, the electrolyzing step S22, the neutralizing step S31, and the heating step S41 can be carried out by utilizing an existing technique.

### Embodiment 5

(Method M50 for Separating Titanium and Lithium from Each Other)

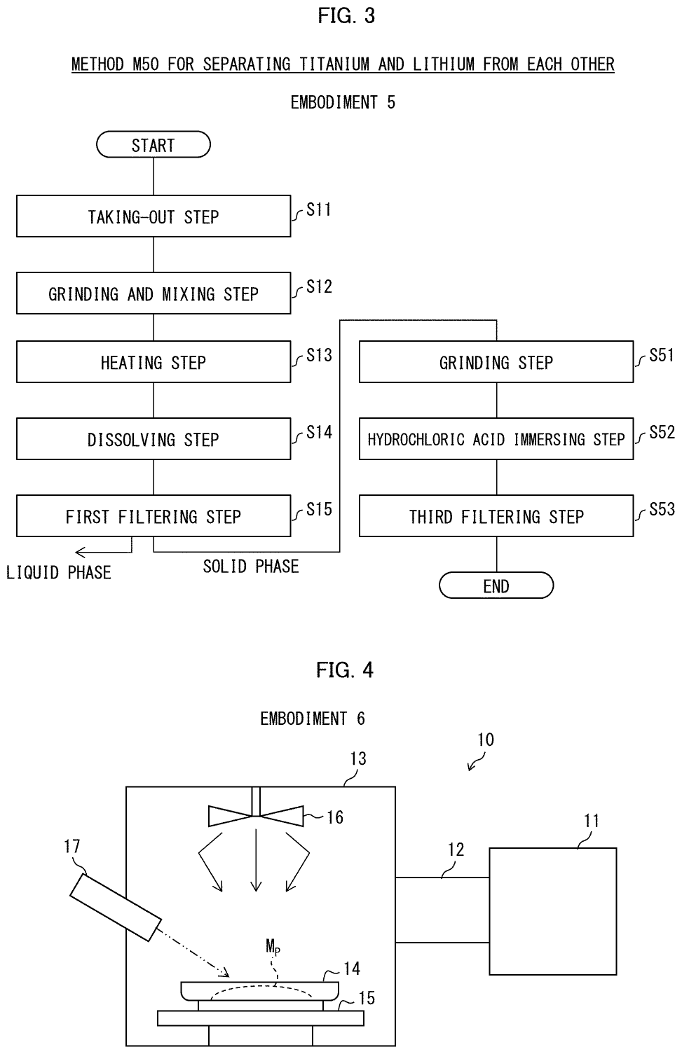

With reference to FIG. 3, the following will discuss a method M50 for separating titanium and lithium from each other in accordance with Embodiment 5 of the present invention. FIG. 3 shows a flowchart of the method M50 for separating titanium and lithium from each other. Hereinafter, the method M50 for separating titanium and lithium from each other may simply be referred to as a separating method M50.

As shown in FIG. 3, the separating method M50 includes the taking-out step S11, the grinding and mixing step S12, the heating step S13, the dissolving step S14, and the first filtering step S15, each of which is included in the production method M10 shown in FIG. 1, as well as a grinding step S51, a hydrochloric acid immersing step S52, and a third filtering step S53. Hereinafter, the taking-out step S11, the grinding and mixing step S12, the heating step S13, the dissolving step S14, and the first filtering step S15 may simply be referred to as the steps S11 to S15, respectively.

The steps S11 to S15 of the production method M10 that are included in the separation method M50 are similar to the steps S11 to S15 described in Embodiment 1. Therefore, a description of the steps S11 to S15 is omitted here. That is, on the basis of an assumption that the lithium titanate contained in the solid phase and the beryllium chloride hydrate and the lithium chloride contained in the liquid phase have been separated from each other, the description of the separating method M50 will deal with only the grinding step S51, the hydrochloric acid immersing step S52, and the third filtering step S53. The solid phase that has undergone the first filtering step S15 may contain not only the lithium titanate but also the titanium oxide.

The grinding step S51 is a step of grinding the lithium titanate contained in the solid phase that has undergone the first filtering step S15 so as to reduce the particle diameter of the lithium titanate. The technique used to grind the lithium titanate is not limited to any particular one, and may be selected from existing techniques as appropriate. Such a technique may be, for example, a technique involving use of a ball mill.

By grinding the lithium titanate into smaller particles, it is possible to increase a percentage of a surface area of the lithium titanate with respect to a total volume of the lithium titanate. This is expected to reduce a period of time taken for lithium contained in the lithium titanate to be dissolved in a solution in the later-described hydrochloric acid immersing step S52. Meanwhile, grinding the lithium titanate into excessively small particles increases a period of time and cost taken for the grinding step S51. Therefore, the particle diameter of the lithium titanate to be obtained through the grinding step S51 is preferably determined in consideration of the period of time taken for the hydrochloric acid immersing step S52, the period of time taken for the grinding step S51, the cost for the grinding step S51, and/or the like.

The particle diameter of the lithium titanate may be any of an average diameter, a mode diameter, and a median diameter. In a case where a particle diameter distribution of the lithium titanate is obtained, the average diameter is a particle diameter corresponding to an average in the particle diameter distribution thus obtained, the mode diameter is a highest frequency particle diameter in the particle diameter distribution, and the median diameter is a particle diameter corresponding to 50% cumulative frequency in the particle diameter distribution.

In the present embodiment, the grinding step S51 is carried out so that the average diameter of the lithium titanate is 100 μm.

The hydrochloric acid immersing step S52 is a step that is to be carried out after the grinding step S51. The hydrochloric acid immersing step S52 is a step of immersing, in a hydrochloric acidic solution, the lithium titanate having been ground through the grinding step S51. As a result of the hydrochloric acid immersing step S52, lithium contained in the lithium titanate is dissolved in the hydrochloric acidic solution as lithium chloride, and titanium contained in the lithium titanate remains in the hydrochloric acidic solution as titanium oxide (e.g., TiO₂). Thus, the hydrochloric acidic solution that has undergone the hydrochloric acid immersing step S52 includes the titanium oxide contained in the solid phase and the lithium chloride contained in the liquid phase.

In order to dissolve, in the hydrochloric acidic solution, lithium contained in the lithium titanate more quickly, a method similar to the heating step S13 may be employed to dielectrically heat the hydrochloric acidic solution containing the lithium titanate.

The third filtering step S53 is a step that is to be carried out after the hydrochloric acid immersing step S52. The third filtering step S53 is a step of separating, with use of a filter, the titanium oxide contained in the solid phase and the lithium chloride contained in the liquid phase from each other.

By carrying out the third filtering step S53, it is possible to easily separate the titanium oxide contained in the solid phase and the lithium chloride contained in the liquid phase from each other.

Similarly to the acidic solution separated in the first filtering step S15, the acidic solution containing the lithium chloride separated in the third filtering step S53 is preferably subjected again to the sodium hydroxide adding step S16. By separating, as lithium chloride, lithium contained in the solid phase separated through the first filtering step S15 and subjecting the lithium chloride again to the sodium hydroxide adding step S16, it is possible to collect a lithium compound more efficiently. In other words, the grinding step S51, the hydrochloric acid immersing step S52, and the third filtering step S53 of the separating method M50 can be included as a part of the production method M10.

As described above, by carrying out the separating method M50, it is possible to isolate titanium and lithium contained in the lithium titanate as titanium oxide and lithium chloride, respectively. Thus, lithium, which is a precious resource, can be collected together with titanium for reuse.

### Embodiment 6

The following description will discuss a dielectric heating device 10 in accordance with Embodiment 6 of the present invention with reference to FIGS. 4 and 5. The dielectric heating device 10 is an example of the beryllium solution production device in accordance with an aspect of the present invention. FIG. 4 is a view schematically illustrating the dielectric heating device 10. The dielectric heating device 10 is a heating device that carries out the heating step S13 included in the production method M10 shown in FIG. 1, and the heating step S13 included in the separating method M50 shown in FIG. 3. In a case where the hydrochloric acidic solution is heated in the dissolving step S14 included in the production method M10, it is possible to use the dielectric heating device 10 also for the heating.

As described in Embodiment 1, the dielectric heating is classified into the radio-frequency heating or the microwave heating depending on the band of an electromagnetic wave to be applied. The dielectric heating device 10 is a device that carries out, among the radio-frequency heating and the microwave heating, the microwave heating with respect to a target object.

<Configuration of Dielectric Heating Device>

As shown in FIG. 4, the dielectric heating device 10 includes an electromagnetic wave generator 11, a waveguide 12, an electromagnetic wave applying section 13, a container 14, a rotary table 15, a stirrer 16, and a thermometer 17. The dielectric heating device 10 further includes an isolator 18 as shown in FIG. 5. The dielectric heating device 10 further includes a control section, which is not shown in FIG. 4.

(Electromagnetic Wave Generator)

The electromagnetic wave generator 11 is configured to oscillate an electromagnetic wave having a given frequency. The given frequency can be selected as appropriate within, for example, the band of a microwave. In the present embodiment, the given frequency is 2.45 GHz. The frequency of 2.45 GHz is identical to that of an electromagnetic wave used in microwave ovens for home use.

(Waveguide)

The waveguide 12 is a metal tubular member. The waveguide 12 has a first end connected with the electromagnetic wave generator 11 and a second end connected with the electromagnetic wave applying section 13 accommodating the later-described container 14. That is, the waveguide 12 is provided between the electromagnetic wave generator 11 and the container 14. The waveguide 12 guides, from the first end to the second end, an electromagnetic wave generated by the electromagnetic wave generator 11. Then, the waveguide 12 discharges the electromagnetic wave from the second end to an internal space of the electromagnetic wave applying section 13 accommodating the container 14. That is, the waveguide 12 guides, from the electromagnetic wave generator 11 toward the container 14, an electromagnetic wave generated by the electromagnetic wave generator 11.

(Isolator)

As shown in FIG. 5, the isolator 18 is provided midway along of the waveguide 12. The isolator 18 includes a circulator 181, a dummy load 182, and a cooling tube 183. The circulator 181 is inserted midway along the waveguide 12.

The circulator 181 includes a magnet (e.g., made of ferrite), and includes three ports P1 to P3 as shown in FIG. 5. The port P1 is connected to the electromagnetic wave generator 11 via one section of the waveguide 12. The port P2 is connected to the electromagnetic wave applying section 13 via the other section of the waveguide 12. The port P3 is provided with the dummy load 182.

A magnetic field formed by the magnet and an electromagnetic wave passing through the circulator 181 interact with each other. Consequently, the electromagnetic wave which has entered the port P1 is emitted from the port P2, and the electromagnetic wave which has entered the port P2 is emitted from the port P3. With the arrangement, the circulator 181 (i) couples the electromagnetic wave generated by the electromagnetic wave generator 11 to the electromagnetic wave applying section 13 and (ii) couples the electromagnetic wave reflected in the internal space of the electromagnetic wave applying section 13 to the dummy load 182.

The dummy load 182 is made of a material that absorbs an electromagnetic wave having a frequency of 2.45 GHz. Therefore, the dummy load 182 absorbs the electromagnetic wave reflected in the internal space of the electromagnetic wave applying section 13, and converts energy of the electromagnetic wave into heat.

The dummy load 182 is provided with the cooling tube 183. The cooling tube 183 has an internal configuration in which a cooled coolant (e.g., water or air) is circulated. The cooled coolant can remove heat from the dummy load 182. Therefore, it is possible to prevent the temperature of the dummy load 182 from excessively rising.

The circulator 181 configured as described above can (i) couple the electromagnetic wave generated by the electromagnetic wave generator 11 to the electromagnetic wave applying section 13 with little loss, and (ii) absorb the electromagnetic wave reflected in the internal space of the electromagnetic wave applying section 13. That is, the circulator 181 can (i) propagate the electromagnetic wave from the electromagnetic wave generator 11 to the container 14 with little loss, and (ii) absorb the electromagnetic wave propagating from the container 14 to the electromagnetic wave generator 11. This makes it possible to reduce a case where the electromagnetic wave reflected in the internal space of the electromagnetic wave applying section 13 returns to the electromagnetic wave generator 11 and adversely affects the operation of the electromagnetic wave generator 11.

(Electromagnetic Wave Applying Section)

The electromagnetic wave applying section 13 is a metal box-shaped member being hollow and having an internal space in which the container 14 can be accommodated. The electromagnetic wave applying section 13 applies, to the container 14 and a target object to be heated (i.e., a heating target object) that is accommodated in the container 14, the electromagnetic wave emitted from the second end of the waveguide 12. The electromagnetic wave applying section 13 is configured to confine an electromagnetic wave in the internal space so that the electromagnetic wave hardly leaks to the outside.

(Container)

The container 14 is a container formed to have a dish shape. The shape of the container 14 is not limited, provided that the container 14 can accommodate a powdery mixture M_{P} of a starting material and sodium hydroxide. For measuring the temperature of the powdery mixture M_{P} with the thermometer 17 (described later), the container 14 preferably has a large opening. In a case where the dissolving step S14 is carried out while continuously using the container 14 after the heating step S13, the container 14 preferably has a capacity that can accommodate a given amount of the hydrochloric acidic solution.

As in later-described Example, in a case where a mortar is used to mix the powder of the starting material with sodium hydroxide (in the later-described Example, powder of sodium hydroxide) to obtain a powdery mixture, the mortar functions as the mixing section. In a case where the powder of the starting material and the powder of the sodium hydroxide are placed in the container 14 and are mixed together in the container 14 to obtain a powdery mixture, the container 14 functions as the mixing section.

The container 14 is preferably made of a material having a high transmittance for an electromagnetic wave (in the present embodiment, an electromagnetic wave of 2.45 GHz) to be oscillated by the electromagnetic wave generator 11. The container 14 is preferably made of a material highly resistant to acids and bases. In a case where the container 14 is made of a material highly resistant to acids and bases, after the heating step S13 is carried out, the dissolving step S14 can be carried out by pouring a hydrochloric acidic solution into the container 14.

In the present embodiment, the container 14 is made of a fluorine-based resin, such as polytetrafluoroethylene. The material constituting the container 14 is not limited to the fluorine-based resin, and may be an aromatic polyether ketone resin such as polyether ether ketone, a polyimide resin, or an oxide such as alumina or titanium oxide.

(Rotary Table)

The rotary table 15 is a sample table provided on a bottom plane of the internal space of the electromagnetic wave applying section 13, and has an upper surface on which the container 14 can be placed. The rotary table 15 has a circular shape in a plan view, and is configured to be rotatable, at a given speed, about a center axis of the circular shape as a rotation axis. With this configuration, the container 14 placed on the upper surface of the rotary table 15 rotates at a given speed. This can heat the powdery mixture M_{P} more uniformly.

(Stirrer)

The stirrer 16 is a metal blade member provided to a ceiling plane of the internal space of the electromagnetic wave applying section 13. The blade member has a center coupled to a supporting rod, with which the blade member is rotatably fixed to the ceiling plane. The stirrer 16 rotates about the supporting rod as a rotation axis at a given speed, thereby reflecting an electromagnetic wave oscillated by the electromagnetic wave generator 11. Consequently, the electromagnetic wave is scattered into the internal space of the electromagnetic wave applying section 13. With this configuration, the stirrer 16 scatters the electromagnetic wave. This can heat the powdery mixture M_{P} more uniformly.

(Thermometer)

The thermometer 17 is a radiation thermometer that detects an infrared ray from the powdery mixture M_{P} to measure the temperature of the container 14. The thermometer 17 is fixed as a part of a side wall of the electromagnetic wave applying section 13 so that a light receiving section of the thermometer 17 can detect an infrared ray from the powdery mixture M_{P}. The thermometer 17 outputs, to the control section, a temperature signal indicative of the measured temperature of the powdery mixture M_{P}.

(Control Section)

The control section may control an output from the electromagnetic wave generator 11 so that the output becomes a given value or so that the temperature indicated by the temperature signal received from the thermometer 17 becomes a predetermined temperature. The predetermined temperature may be constant or may be changed over time. In the present embodiment, the control section controls an output from the electromagnetic wave generator 11 so as to change the value of the output over time. One example of the output control pattern may be a pattern in which an output of 300 W is maintained for 600 seconds and the output is then made to 0 W.

The production method M10 is taken as an example. Then, by accommodating the powdery mixture M_{P} in the internal space of the container 14 of the dielectric heating device 10 configured as above, it is possible to carry out the heating step S13. Moreover, it is possible to carry out the dissolving step S14 by pouring a hydrochloric acidic solution into the container 14 after the heating step S13 is carried out. In a case where the dielectric heating device 10 is used to carry out the dissolving step S14, it is possible to heat the hydrochloric acidic solution. Therefore, it is possible to promote the dissolution of the liquid mixture in the hydrochloric acidic solution. The hydrochloric acidic solution of the liquid mixture is an example of the inorganic substance solution.

### Example 1

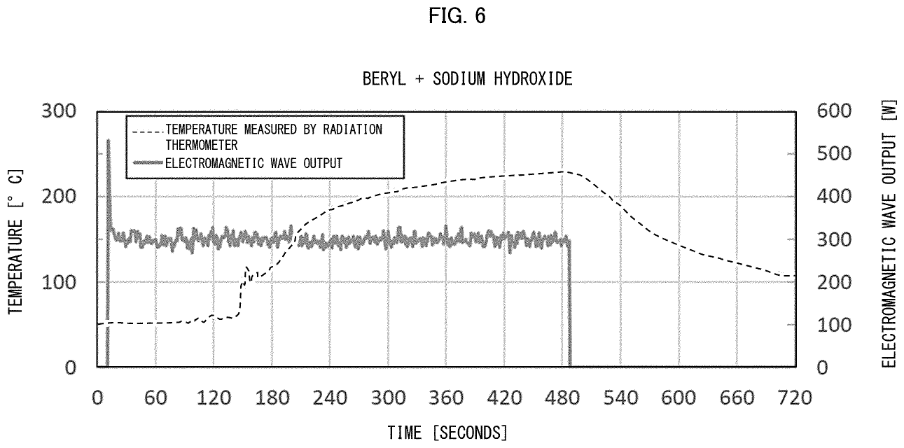

The following description will discuss Example 1 of the production method M10 in which the dielectric heating device 10 is used, with reference to FIG. 6. FIG. 6 is a graph showing a change in temperature of a mixture M in an example of the foregoing heating step S13. In this Example, beryl was used as the starting material.

In this Example, in the grinding and mixing step S12, the beryl was ground with use of a ball mill. The particle diameter of the beryl after the grinding and mixing step S12 was carried out was not larger than 150 μm. With use of a mortar, sodium hydroxide was ground for 30 minutes. Then, the powder of the beryl and the powder of the sodium hydroxide were weighed and collected by 0.2 g and 2 g, respectively, and were mixed together with use of a mortar to obtain a powdery mixture M_{P}.

In this Example, in the heating step S13, the powdery mixture M_{P} was placed on a container 14 made of aluminum oxide (alumina: Al₂O₃), and was dielectrically heated by the dielectric heating device 10 in the air atmosphere under normal pressure. The output value of the dielectric heating device 10 was set to 300 W, and the heating time was set to 8 minutes. By carrying out the heating step S13, the powdery mixture M_{P} was fused through the dielectric heating, and the powdery mixture M_{P} entirely became a liquid mixture in the form of emulsion after 8 minutes. Hereinafter, when it is not necessary to distinguish whether the mixture is in the form of powder or liquid, the mixture is referred to simply as a mixture M. In the heating step S13 in this Example, the maximum temperature of the mixture M was approximately 220° C.

After the output value was set to 300 W, the temperature of the mixture M continued to show 50° C. in the section from 0 seconds to approximately 345 seconds. This is because the lower limit temperature detectable by the thermometer 17 was 50° C.

In this Example, the liquid mixture was cooled to normal temperature, and then, in the dissolving step S14, the liquid mixture was charged into an aqueous hydrochloric acidic solution (HCl: 6 mol/L, 20 cm³) in the air atmosphere, at room temperature, and under normal pressure. Consequently, the liquid mixture was completely dissolved in the aqueous hydrochloric acidic solution (99% dissolution of beryllium was confirmed).

### Example 2

The following description will discuss Example 2 of the production method M10 in which the dielectric heating device 10 is used. In this Example, spodumene (LiAlSi₂O₆), which is an example of a lithium ore, was used as the starting material.

In this Example, in the grinding and mixing step S12, the spodumene was ground with use of a ball mill. The particle diameter of the spodumene after the grinding and mixing step S12 was carried out was not larger than 150 μm. With use of a mortar, sodium hydroxide was ground for 30 minutes. Then, the powder of the spodumene and the powder of the sodium hydroxide were weighed and collected by 0.2 g and 2 g, respectively, and were mixed together with use of a mortar to obtain a powdery mixture M_{P}.

In this Example, in the heating step S13, the powdery mixture M_{P} was placed on a container 14 made of aluminum oxide (alumina: Al₂O₃), and was dielectrically heated by the dielectric heating device 10 in the air atmosphere under normal pressure. The temperature history through the dielectric heating exhibited the tendency similar to that shown in FIG. 6. The output value of the dielectric heating device 10 was set to 300 W, and the heating time was set to 8 minutes. By carrying out the heating step S13, the powdery mixture M_{P} was fused through the dielectric heating, and the powdery mixture M_{P} entirely became a liquid mixture in the form of emulsion after 8 minutes. Hereinafter, when it is not necessary to distinguish whether the mixture is in the form of powder or liquid, the mixture is referred to simply as a mixture M. In the heating step S13 in this Example, the maximum temperature of the mixture M was approximately 220° C.

In this Example, the liquid mixture was cooled to normal temperature, and then, in the dissolving step S14, the liquid mixture was charged into an aqueous hydrochloric acidic solution (HCl: 6 mol/L, 20 cm³) in the air atmosphere, at room temperature, and under normal pressure. Consequently, the liquid mixture was dissolved in the aqueous hydrochloric acidic solution (90% or higher dissolution of lithium was confirmed).

### Reference Example

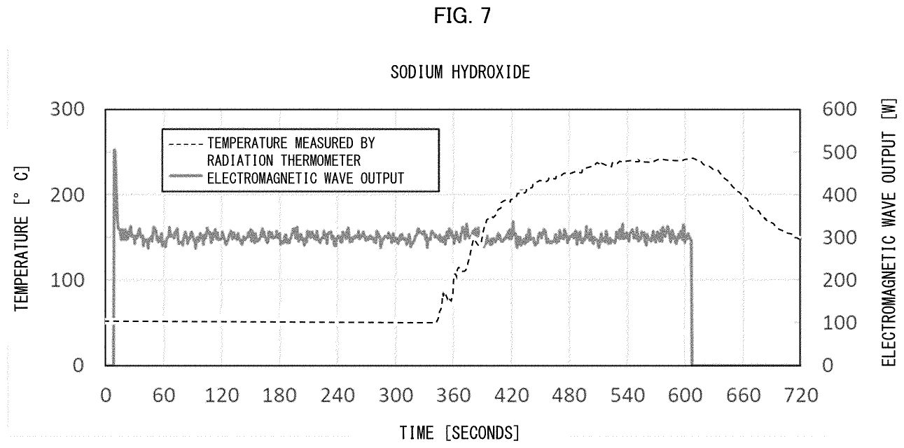

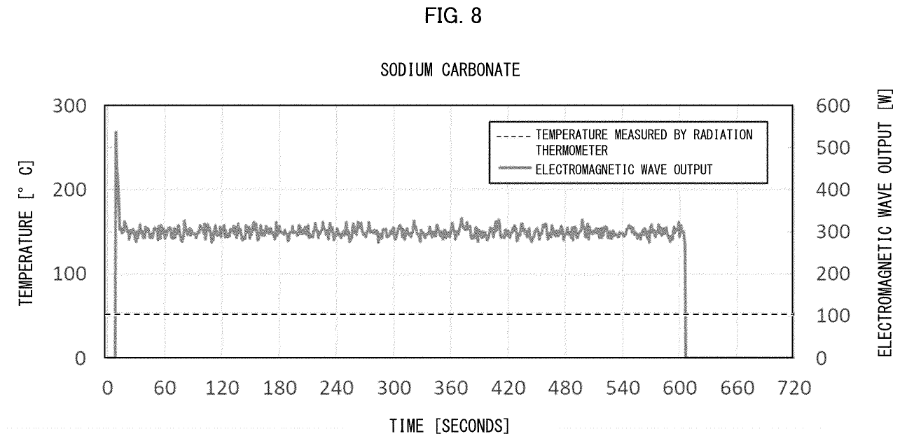

As a reference example of the heating step S13 included in the production method M10, dielectric heating of powder of sodium hydroxide and powder of sodium hydrogencarbonate was carried out. The results will be described with reference to FIGS. 7 and 8. FIG. 7 is a graph showing a change in temperature of the sodium hydroxide obtained as a result of dielectric heating of the powder of sodium hydroxide. FIG. 8 is a graph showing a change in temperature of the sodium hydrogencarbonate obtained as a result of dielectric heating of the powder of sodium hydrogencarbonate.

Similarly to the case of Examples described above, the sodium hydroxide and the sodium hydrogencarbonate were each ground with a mortar for 30 minutes. Then, the sodium hydroxide and the sodium hydrogencarbonate were each weighed and collected by 2 g, and were dielectrically heated by the dielectric heating device 10. In this reference example, the output value of the dielectric heating device 10 was set to 300 W, and the heating time was set to 10 minutes.

With reference to FIG. 7, it was found that the powder of the sodium hydroxide was heated by carrying out the dielectric heating, and the maximum temperature was approximately 250° C. After the dielectric heating was carried out, the sodium hydroxide was fused to be a liquid form. From this result, in the heating step S13 of the production method M10, it is considered that the sodium hydroxide in the powdery mixture M_{P} absorbs energy of an electromagnetic wave used for dielectric heating.

Meanwhile, with reference to FIG. 8, it was found that, even after dielectric heating was carried out, the temperature of the powder of the sodium carbonate hardly increased. In FIG. 8, the temperature of the sodium carbonate is lower than 50° C., which is the lower limit temperature detectable by the thermometer 17. From this result, it is considered that sodium carbonate used in the conventionally known alkali melting method hardly absorbs energy of an electromagnetic wave used for dielectric heating.

Note that, although a graph is omitted, the following fact has been found, that is, in a case where dielectric heating is carried out on at least one of powder of beryl and powder of spodumene, the temperature of the at least one of powder of beryl and powder of spodumene is hardly increased, as with the case of the powder of sodium carbonate. From this result, it is considered that beryl and spodumene which are not mixed with sodium hydroxide hardly absorb energy of an electromagnetic wave used for dielectric heating.

### Embodiment 7

<Beryllium Production System>

The following description will discuss a beryllium production system 20 in accordance with Embodiment 7 of the present invention with reference to FIGS. 9 and 10. FIG. 9 is a view schematically illustrating a beryllium solution (BeCl₂ solution) production device 20A constituting a part of the beryllium production system 20. (a) of FIG. 10 is a view schematically illustrating a crystallizer 20B, an anhydrization device 20C, and an electrolyzing device 20D. (b) of FIG. 10 is a view schematically illustrating a variation of a crystallization treatment tank 31 included in the crystallizer 20B shown in (a) of FIG. 10. (c) of FIG. 10 is a view schematically illustrating a variation of a dryer 33 included in the anhydrization device 20C shown in (a) of FIG. 10. Each of the crystallizer 20B, the anhydrization device 20C, and the electrolyzing device 20D constitutes a part of the beryllium production system 20. Hereinafter, the beryllium production system 20 may also simply be referred to as a production system 20, and the beryllium solution production device 20A may also simply be referred to as a production device 20A.

As shown in FIGS. 9 and 10, the production system 20 is a device that includes the production device 20A, the crystallizer 20B, the anhydrization device 20C, and the electrolyzing device 20D and that is configured to carry out the production method M20 shown in (a) of FIG. 2. More specifically, the production device 20A is a device that is configured to execute the steps of the production method M10 shown in FIG. 1 except for the taking-out step S11. The crystallizer 20B and the anhydrization device 20C are devices configured to execute the anhydrization step S21 shown in (a) of FIG. 2. The electrolyzing device 20D is a device configured to execute the electrolyzing step S22 shown in (a) of FIG. 2.

Similarly to Embodiment 1, the present embodiment employs, as the starting material, lithium titanate (Li₂TiO₃), which is one example of the tritium breeder material, and also employs beryllium (Be), which is one example of the neutron multiplying material, having a surface on which an oxidized layer made of beryllium oxide (BeO) is formed. Note that the starting material in the production device 20A is not limited to lithium titanate (Li₂TiO₃) and beryllium (Be) having a surface on which an oxidized layer made of beryllium oxide (BeO) is formed, as exemplified in Embodiment 1.

(Beryllium Solution Production Device 20A)

As shown in FIG. 9, the production device 20A includes a grinder 21a, a feeder Fla, a grinder 21b, a feeder F1b, valves V1 to V15, a dielectric heating device 22, filters 23 and 29, containers 24, 26, 27, 28, and 30, and a centrifuge 25. The production device 20A further includes a control section, which is not shown in FIG. 9. The control section controls the feeders Fla and F1b, the valves V1 to V15, and the dielectric heating device 22.

The grinder 21a grinds, into powder, lithium titanate and beryllium having a surface on which an oxidized layer is formed, the lithium titanate and the beryllium being the starting material charged thereto. Then, the grinder 21a supplies the powder of lithium titanate and beryllium to the feeder Fla. The grinder 21a can be selected as appropriate from existing grinders according to desired specifications. Thus, a detailed description of the grinder 21a is omitted here. With the configuration in which the grinder 21a grinds the starting material, even in a case where beryllium, which is one example of the neutron multiplying material, has a surface on which an oxidized layer is formed, it is possible to mechanically break the oxidized layer so that beryllium having been covered with the oxidized layer is exposed. Thus, it is possible to increase the rate at which beryllium is fused together with sodium hydroxide in the heating step S13.

The feeder Fla, which is controlled by the control section, supplies, to the container 22c of the dielectric heating device 22 (described later), the starting material supplied from the grinder 21a. The feeder Fla is one example of a raw material supplying section configured to supply the starting material to the container 22c.

The grinder 21b grinds, into powder, sodium hydroxide charged thereto. Then, the grinder 21b supplies the powder of sodium hydroxide to the feeder Fib. The grinder 21b can be selected as appropriate from existing grinders according to desired specifications. Thus, a detailed description of the grinder 21b is omitted here. By grinding the sodium hydroxide with the grinder 21b, it is possible to reduce the particle diameter of the sodium hydroxide to a desired size. As described above, the form of the sodium hydroxide is not limited to powder. Therefore, in the production device 20A, the grinder 21b can be omitted.

The feeder Fla, which is controlled by the control section, supplies, to the container 22c of the dielectric heating device 22 (described later), the powder of the starting material supplied from the grinder 21a. The feeder Fla is one example of the raw material supplying section configured to supply the starting material to the container 22c. Similarly, the feeder F1b, which is controlled by the control section, supplies, to the container 22c of the dielectric heating device 22 (described later), the powder of sodium hydroxide supplied from the grinder 21b. The feeder F1b is one example of a hydroxide supplying section configured to supply sodium hydroxide to the container 22c.

The dielectric heating device 22 includes an electromagnetic wave generator 22a, a waveguide 22b, the container 22c, a stirring mechanism, and a thermometer. The dielectric heating device 22 carries out the heating step S13 and the dissolving step S14 of the production method M10 shown in FIG. 1.

The electromagnetic wave generator 22a is controlled by the control section, and is configured to oscillate an electromagnetic wave having a given frequency. The given frequency can be selected as appropriate within, for example, the band of a microwave. In the present embodiment, the given frequency is 2.45 GHz. The frequency of 2.45 GHz is identical to that of an electromagnetic wave used in microwave ovens for home use.

The waveguide 22b is a metal tubular member having a first end connected with the electromagnetic wave generator 22a and a second end connected with the container 22c. The waveguide 22b guides, from the first end to the second end, an electromagnetic wave oscillated by the electromagnetic wave generator 22a. Then, the waveguide 22b discharges the electromagnetic wave into an internal space of the container 22c through the second end. Although not shown in FIG. 9, an isolator shown in FIG. 5 is provided midway along the waveguide 22b. In this case, the waveguide 12 shown in FIG. 5 may be read as the waveguide 22b.

The container 22c is a box-shaped member that accommodates, in its internal space, the powder of the starting material and the powder of the sodium hydroxide. Similarly to the container 14 shown in FIG. 4, the container 22c is made of a material having acid resistance. To the container 22c, powder of the starting material supplied from the grinder 21a via the feeder Fla and powder of sodium hydroxide supplied from the grinder 21b via the feeder F1b are supplied. Inside the container 22c, a stirring mechanism (not shown in FIG. 9) is provided. When the control section causes the stirring mechanism to rotate, the powder of the starting material and the powder of the sodium hydroxide supplied to the internal space of the container 22c are mixed together into a powdery mixture. As such, the container 22c is one example of the mixing section that mixes the powder of the starting material with the powder of sodium hydroxide to obtain a powdery mixture. The container 22c may be a tubular container (e.g., a rotary kiln) that is rotatable about an axis. By combining a liquid supplying section (described later) with the rotary kiln, it is possible to carry out a continuous treatment.

The thermometer (not shown in FIG. 9) detects the temperature of a matter (at this point in time, the powdery mixture) accommodated in the internal space of the container 22c, and outputs a temperature signal indicative of the temperature to the control section. The thermometer may be a noncontact-type thermometer such as a radiation thermometer or a contact-type thermometer such as a thermocouple. Either in a case of employing the noncontact-type thermometer or a case of employing the contact-type thermometer, the thermometer is preferably provided in the internal space of the container 22c and is preferably configured to be capable of directly detecting the temperature of the matter accommodated in the internal space.

The control section may control an output from the electromagnetic wave generator 22a so that the output becomes a given value or so that the temperature indicated by the temperature signal received from the thermometer becomes a predetermined temperature. The predetermined temperature may be constant or may be changed over time. In the present embodiment, the control section controls an output from the electromagnetic wave generator 22a so as to change the temperature indicated by the temperature signal over time according to a given profile. One example of the given profile of the temperature may be a pattern according to which the temperature is changed from room temperature to 250° C. in 5 minutes and then is maintained at 250° C. for 10 minutes.

In a case where the heating step S13 of the production method M10 shown in FIG. 1 is carried out with the dielectric heating device 22 configured as described above, a liquid mixture containing the starting material and the sodium hydroxide is obtained.

Then, an HCl solution is supplied via the valve V1. By supplying the HCl solution to the container 22c via the valve V1, the dissolving step S14 is carried out. The mechanism that supplies the HCl solution to the container 22c via the valve V1 functions as the liquid supplying section that supplies an acidic solution to the liquid mixture. In the container 22c, the liquid mixture is dissolved in the HCl solution, and a beryllium solution containing lithium (BeCl₂ solution) is obtained. As described above, the liquid for dissolving the liquid mixture containing the starting material and the sodium hydroxide is not limited to an acid solution such as an HCl solution, and may alternatively be water. In a case where water is used as the liquid, the dissolving step S14 is carried out by supplying the water to the container 22c via the valve V1.

While the dissolving step S14 is being carried out, the control section may control an output from the electromagnetic wave generator 22a so that the output becomes a given value or so that the temperature indicated by the temperature signal received from the thermometer becomes a predetermined temperature. By carrying out the dielectric heating also during the dissolving step S14, dissolution of the liquid mixture in the HCl solution is promoted. While the dissolving step S14 is being carried out, the control section may cause the stirring mechanism to continue to operate.

The valve V2 opens and closes a passage between the internal space of the container 22c and a filter 23 (described later). The control section closes the valve V2 while the heating step S13 and the dissolving step S14 are being carried out, and opens the valve V2 after the heating step S13 and the dissolving step S14 end. Consequently, the beryllium solution containing lithium obtained as a result of the heating step S13 is supplied from the container 22c to the filter 23.

The filter 23 is configured to allow the liquid phase (i.e., the BeCl₂ solution containing LiCl) of the beryllium solution containing lithium to pass therethrough and to catch the solid phase (i.e., titanium oxide) of the beryllium solution containing lithium. That is, the filter 23 carries out the first filtering step S15 of the production method M10. The filter 23 can be selected as appropriate from existing filters according to desired specifications. Thus, a detailed description of the filter 23 is omitted here.

The valve V3 opens and closes a passage between the filter 23 and the later-described container 24. The control section opens the valve V3 at least during a period in which the beryllium solution containing lithium is being supplied to the filter 23. Consequently, the BeCl₂ solution containing LiCl obtained as a result of the first filtering step S15 is supplied from the filter 23 to the container 24.

The container 24 is a box-shaped member that is hollow, that has acid resistance, and that has basic resistance. The later-described containers 26, 27, 28, and 30 are each configured as a box-shaped member having acid resistance. The container 24 is supplied with an NaOH solution via the valve V4. The mechanism that supplies the NaOH solution to the beryllium solution in the container 24 via the valve V4 functions as an NaOH solution supplying section that supplies the NaOH solution to the beryllium solution.

The BeCl₂ solution containing LiCl and the NaOH solution having been supplied to the container 24 are mixed together in the internal space of the container 24. That is, in the internal space of the container 24, the sodium hydroxide adding step S16 of the production method M10 is carried out. Consequently, in the container 24, beryllium hydroxide (Be(OH)₂) that is a solid phase is generated, and LiOH that is a liquid phase is dissolved in the NaOH solution.

Although not shown in FIG. 9, a stirring mechanism for stirring the BeCl₂ solution containing LiCl and the NaOH solution may be provided in the internal space of the container 24. Similarly, stirring mechanisms may be provided in the internal spaces of the later-described containers 26, 27, 28, and 30, respectively.

The valve V5 opens and closes a passage between the internal space of the container 24 and the later-described centrifuge 25. The control section closes the valve V5 while the sodium hydroxide adding step S16 is being carried out, and opens the valve V5 after the sodium hydroxide adding step S16 ends. Consequently, the NaOH solution containing Be(OH)₂ and LiOH obtained as a result of the sodium hydroxide adding step S16 is supplied from the container 24 to the centrifuge 25.

The centrifuge 25 separates the liquid phase (i.e., the NaOH solution containing LiOH) and the solid phase (i.e., Be(OH)₂) from each other in the NaOH solution containing Be(OH)₂ and LiOH. That is, the centrifuge 25 carries out the second filtering step S17 of the production method M10. The centrifuge 25 can be selected as appropriate from existing centrifuges according to desired specifications. Thus, a detailed description of the centrifuge 25 is omitted here. Be(OH)₂ obtained as a result of the second filtering step S17 is charged into the internal space of the later-described container 26, and the aqueous NaOH solution containing LiOH obtained as a result of the second filtering step S17 is collected into a collection line (not illustrated).

In order to separate the liquid phase and the solid phase from each other in the NaOH solution containing Be(OH)₂ and LiOH, a filter such as the filter 23 can be used instead of the centrifuge 25.

The container 26 is supplied with the HCl solution via the valve V6. Be(OH)₂ and the HCl solution supplied to the container 26 are mixed together in the internal space of the container 26. That is, in the internal space of the container 26, the hydrochloric acid adding step S18 of the production method M10 is carried out. Consequently, in the container 26, BeCl₂ generated as a result of the mixing is dissolved in the HCl solution to yield a beryllium solution (BeCl₂ solution).

The valve V7 opens and closes a passage between the internal space of the container 26 and the internal space of the later-described container 27. The control section closes the valve V7 while the hydrochloric acid adding step S18 is being carried out, and opens the valve V7 after the hydrochloric acid adding step S18 ends. Consequently, the beryllium solution obtained as a result of the hydrochloric acid adding step S18 is supplied from the container 26 to the container 27.

The container 27 is supplied with an organic compound solution via the valve V8. The mechanism that supplies the organic compound solution to the container 27 via the valve V8 functions as an organic compound solution supplying section that supplies the organic compound solution to the beryllium chloride solution. The organic compound solution is the organic compound solution explained in the description of the first impurity removing step S19 of the production method M10. Thus, a description of the organic compound solution is omitted here.

The beryllium solution and the organic compound solution supplied to the container 27 are mixed together in the internal space of the container 27. That is, in the internal space of the container 27, the first impurity removing step S19 is carried out. Consequently, in the container 27, the beryllium solution in which the content of the first element has been reduced and the organic compound solution containing the first element are separated into two layers. Since the specific gravity of the beryllium solution is higher than that of the organic compound solution, the beryllium solution goes under the organic compound solution.

The valve V9 opens and closes a passage between the internal space of the container 27 and the collection line (not illustrated). The valve V10 opens and closes a passage between the internal space of the container 27 and the internal space of the later-described container 28.

The control section closes both the valves V9 and V10 while the first impurity removing step S19 is being carried out. After the first impurity removing step S19 is carried out, the control section first opens only the valve V10. Consequently, the beryllium solution which is obtained as a result of the first impurity removing step S19 and in which the content of the first element has been reduced is supplied from the container 27 to the container 28. Thereafter, the control section closes the valve V10 and opens the valve V9. Consequently, the organic compound solution which is obtained as a result of the first impurity removing step S19 and which contains the first element is collected into the collection line.

The container 28 is supplied with sodium bicarbonate via the valve V11. The mechanism that supplies the sodium bicarbonate to the container 28 via the valve V11 functions as a sodium bicarbonate supplying section that supplies the sodium bicarbonate to the beryllium chloride solution. The sodium bicarbonate is the sodium bicarbonate in the description of the second impurity removing step S20 of the production method M10. Thus, a description of the sodium bicarbonate is omitted here.

The beryllium solution and the sodium bicarbonate supplied to the container 28 are mixed together in the internal space of the container 28. That is, in the internal space of the container 28, the second impurity removing step S20 is carried out. Consequently, in the container 28, hydroxide of the second element is precipitated and the content of the second element in the beryllium hydroxide (Be(OH)₂) solution is reduced.

The valve V12 opens and closes a passage between the internal space of the container 28 and the later-described filter. The control section closes the valve V12 while the second impurity removing step S20 is being carried out, and opens the valve V12 after the second impurity removing step S20 ends. Consequently, the beryllium hydroxide solution that is obtained as a result of the second impurity removing step S20 and that contains hydroxide of the second element is supplied from the container 28 to the filter 29.

The filter 29 is configured to allow the liquid phase (i.e., the beryllium hydroxide solution) of the beryllium hydroxide solution containing hydroxide of the second element to pass therethrough and to catch the solid phase (i.e., hydroxide of the second element) of the beryllium hydroxide solution containing hydroxide. The filter 29 can be selected as appropriate from existing filters according to desired specifications. Thus, a detailed description of the filter 29 is omitted here.

The valve V13 opens and closes a passage between the filter 29 and the later-described container 30. The control section opens the valve V13 at least during a period in which the beryllium hydroxide solution containing the hydroxide of the second element is being supplied to the filter 29. Consequently, the beryllium hydroxide solution which is obtained as a result of the second impurity removing step S20 and in which the content of the second element has been reduced is supplied from the filter 29 to the container 30.

The container 30 is supplied with the beryllium hydroxide solution via the valve V13, and is supplied with the HCl solution via the valve V14. The Be(OH)₂ solution and the HCl solution supplied to the container 30 are mixed together in the internal space of the container 30. Consequently, in the container 30, BeCl₂ generated as a result of the mixing is dissolved in the HCl solution to yield a beryllium solution (BeCl₂ solution).

The valve V15 opens and closes a passage between the container 30 and the later-described crystallization treatment tank 31 of the crystallizer 20B. The control section closes the valve V15 at least during a period in which the HCl solution is being supplied to the container 30, and opens the valve V15 after the Be(OH)₂ solution and the HCl solution supplied to the container 30 are mixed sufficiently. Consequently, the beryllium solution (BeCl₂ solution) is supplied from the container 30 to the crystallization treatment tank 31.

(Crystallizer 20B)

As shown in (a) of FIG. 10, the crystallizer 20B includes the crystallization treatment tank 31, a chiller C, a pump P, a condensation tank, and valves V16 and V17. The crystallizer 20B further includes a control section, which is not illustrated in (a) of FIG. 10. The control section controls the crystallization treatment tank 31, the chiller C, the pump P, and the valves V16 and V17.

The crystallization treatment tank 31 includes an inner tank and an outer tank. The outer tank has an internal space to which hot water is to be supplied via the valve V16. The inner tank has an internal space to which the beryllium solution (BeCl₂ solution) generated by the production device 20A is to be supplied. The hot water heats the beryllium solution and the HCl solution accommodated in the inner tank. Use of the hot water is one example of a heating way employing an external heating method.

The chiller C, the condensation tank, and the pump P constitute a reduced pressure dehydration system. The pump P discharges a gas of the internal space of the inner tank. The chiller C cools the gas discharged from the internal space of the inner tank. The condensation tank stores therein condensed water obtained as a result of cooling carried out by the chiller C.

The crystallizer 20B configured as above can crystalize beryllium chloride. The beryllium chloride obtained as a result of crystallization is supplied from the crystallization treatment tank 31 to the later-described centrifuge 32 via the valve V17.

Note that, as shown in (b) of FIG. 10, the crystallization treatment tank 31 may include an electromagnetic wave generator 31a and a waveguide 31b in place of the valve V16 through which the hot water is to be supplied. The electromagnetic wave generator 31a and the waveguide 31b are respectively configured similarly to the electromagnetic wave generator 22a and the waveguide 22b shown in FIG. 9, and are one example of the dielectric heating device.

As described above, the heating way employed in the crystallizer 20B and configured to heat the beryllium solution and the HCl solution may be the external heating method such as that shown in (a) of FIG. 10 or the dielectric heating method such as that shown in (b) of FIG. 10. From the viewpoint of energy efficiency, it is preferable to employ the dielectric heating method.

(Anhydrization Device 20C)

As shown in (a) of FIG. 10, the anhydrization device 20C includes a centrifuge 32 and a dryer 33. The anhydrization device 20C further includes a control section, which is not illustrated in (a) of FIG. 10. The control section controls the centrifuge 32 and the dryer 33.

The beryllium chloride obtained as a result of crystallization carried out by the crystallizer 20B is dehydrated by the centrifuge 32. The dehydrated beryllium chloride is subjected to anhydrization with the dryer 33. One example of the dryer 33 can be a hot-air generating mechanism for generating hot air. The beryllium chloride is heated by hot air generated by the hot-air generating mechanism so as to be anhydrous. That is, the crystallizer 20B and the anhydrization device 20C are one example of the anhydrization device recited in the claims, and can carry out the anhydrization step S21 of the production method M20 shown in FIG. 2. The hot air is one example of the heating way employing the external heating method.

Note that the dryer 33 may include an electromagnetic wave generator 33a and a waveguide 33b in place of the hot-air generating mechanism for generating hot air (see (c) of FIG. 10). The electromagnetic wave generator 33a and the waveguide 33b are respectively configured similarly to the electromagnetic wave generator 22a and the waveguide 22b shown in FIG. 9, and are one example of the dielectric heating device.

As described above, the heating way employed in the anhydrization device 20C and configured to heat the beryllium chloride may be the external heating method such as that shown in (a) of FIG. 10 or the dielectric heating method such as that shown in (c) of FIG. 10. From the viewpoint of energy efficiency, it is preferable to employ the dielectric heating method.

(Electrolyzing Device 20D)

As shown in (a) of FIG. 10, the electrolyzing device 20D includes an electrolytic furnace 34a, a power source 34b, a positive electrode 34c, a negative electrode 34d, and a feeder F2. The electrolytic furnace 34a includes a heater, which is not illustrated in (a) of FIG. 10. The electrolyzing device 20D further includes a control section, which is not illustrated in (a) of FIG. 10. The control section controls the power source 34b, the heater, and the feeder F2.

Into the electrolytic furnace 34a, the anhydrous beryllium chloride generated by the anhydrization device 20C is supplied. Into the electrolytic furnace 34a, sodium chloride (NaCl) is supplied via the feeder F2.

The electrolytic furnace 34a accommodating the beryllium chloride and the sodium chloride therein is heated by the heater. Consequently, the beryllium chloride and the sodium chloride are melted. A binary bath containing beryllium chloride and sodium chloride thereto may be used as an electrolytic bath. This makes it possible to lower the melting point of the electrolytic bath. A temperature to which the electrolytic furnace 34a is heated can be appropriately set in a range above the melting point of the binary bath. The temperature of the electrolytic furnace 34a may be 350° C., for example.

The positive electrode 34c is, for example, an electrode made of carbon, and the negative electrode 34d is, for example, an electrode made of nickel.

In a state where the binary bath is melted, the control section causes an electric current to flow between the positive electrode 34c and the negative electrode 34d with use of the power source 34b. Consequently, the binary bath is electrolyzed, so that metal beryllium is formed on the surface of the negative electrode 34d.

In the above-described manner, the electrolyzing device 20D can carry out the electrolyzing step S22 of the production method M20 shown in FIG. 2.

### OTHER EMBODIMENTS

The description in Embodiment 7 has dealt with the beryllium production system 20 that involves use of the production device 20A, the crystallizer 20B, and the anhydrization device 20C and that is configured to carry out the production method M20.

The scope of the present invention encompasses not only the beryllium production system 20 but also a beryllium hydroxide production system that is configured to carry out the method M30 for producing beryllium hydroxide and a beryllium oxide production system configured to carry out the method M40 for producing beryllium oxide.

The beryllium hydroxide production system includes the production device 20A shown in FIG. 9 and a neutralization device that neutralizes, with a base, a beryllium chloride solution produced by the production device 20A so as to generate beryllium hydroxide. The neutralization device can be constituted by members respectively corresponding to the container 24, the valves V4 and V5, and the centrifuge 25 shown in FIG. 9, for example. The base used for neutralization may be ammonium, rather than sodium hydroxide.

The beryllium oxide production system includes the production device 20A shown in FIG. 9 and a third heating device that heats a beryllium chloride solution produced by the production device 20A so as to generate beryllium oxide. The third heating device is not limited to any particular one, but may be an electric furnace, for example.

In the sections of (Variation of method for producing beryllium solution) and (Method for producing lithium solution), it has been described that, in a case where a beryllium ore (e.g., beryl) or a lithium ore (e.g., spodumene) is used as the starting material, the sodium hydroxide adding step S16, the second filtering step S17, and the hydrochloric acid adding step S18 can be omitted. Therefore, in a case where the production device 20A is used and a beryllium ore or a lithium ore is used as the starting material, it is possible to omit the feature of carrying out the sodium hydroxide adding step S16, the second filtering step S17, and the hydrochloric acid adding step S18. That is, the beryllium solution or the lithium solution which is supplied via the valve V3 and obtained through the first filtering step S15 may be supplied directly to the container 27.

### Embodiments 8 and 9

With reference to FIG. 11, the following will discuss a method M70 for producing lithium hydroxide (LiOH) in accordance with Embodiment 8 of the present invention and a method M80 for producing lithium carbonate (Li₂CO₃) in accordance with Embodiment 9 of the present invention. (a) and (b) of FIG. 11 respectively show a flowchart of the method M70 for producing lithium hydroxide and a flowchart of the method M80 for producing lithium carbonate.

Each of the method M70 for producing lithium hydroxide and the method M80 for producing lithium carbonate uses the solution that is separated as the liquid phase through the second filtering step S17 and that contains the lithium hydroxide. According to a priority at that time, it is possible to appropriately determine whether the method M70 for producing lithium hydroxide or the method M80 for producing lithium carbonate is to be carried out.

(Method M70 for Producing Lithium Hydroxide)

As shown in (a) of FIG. 11, the method M70 for producing lithium hydroxide includes a drying step S71. The drying step S71 is a step of evaporating the solution obtained as a result of separation in the second filtering step S17 and drying the lithium hydroxide having been deposited. By carrying out the method M70 for producing lithium hydroxide, it is possible to obtain lithium hydroxide that is a solid.

(Method M80 for Producing Lithium Carbonate)

As shown in (b) of FIG. 11, the method M80 for producing lithium carbonate includes a carbon dioxide gas introduction step S81, a fourth filtering step S82, and a drying step S83.

The carbon dioxide gas introduction step S81 is a step that introduces carbon dioxide gas into the solution obtained as a result of separation in the second filtering step S17 so that lithium carbonate is precipitated in the solution.

The fourth filtering step S82 is a step that is to be carried out after the carbon dioxide gas introduction step S81. The fourth filtering step S82 is a step of separating, from the solution, the lithium carbonate precipitated in the solution, with use of a filter.

The drying step S83 is a step that is to be carried out after the fourth filtering step S82. The drying step S83 is a step of drying the lithium carbonate obtained as a result of separation in the fourth filtering step S82.

By carrying out the method M80 for producing lithium carbonate, it is possible to obtain lithium carbonate that is a solid.

(Conclusion)

As described above, by carrying out the method M70 for producing lithium hydroxide or the method M80 for producing lithium carbonate with use of the solution containing the lithium hydroxide obtained as the liquid phase through separation in the second filtering step S17, it is possible to produce lithium hydroxide or lithium carbonate each being a solid. Thus, the lithium hydroxide obtained as the liquid phase through the second filtering step S17 can be collected as a resource, without wasting the lithium hydroxide.

Note that, similarly to the separating method M50, each of the method M70 for producing lithium hydroxide and the method M80 for producing lithium carbonate can be included as a part of the production method M10.

### Embodiment 10

The following description will discuss a method M90 for producing lithium carbonate (Li₂CO₃) in accordance with Embodiment 10 of the present invention with reference to FIG. 12. FIG. 12 shows a flowchart of the production method M90. In the present embodiment, spodumene (LiAlSi₂O₆), which is an example of the lithium ore, is used as the starting material.

As shown in FIG. 12, the production method M90 includes a grinding and mixing step S12, a heating step S13, a dissolving step S14, a first filtering step S15, a sodium hydroxide adding step S16, a second filtering step S17, a carbon dioxide gas introduction step S91, a separating step S92, and a drying step S93.

The grinding and mixing step S12 through the second filtering step S17 in the production method M90 are identical with the grinding and mixing step S12 through the second filtering step S17 in the production method M10, except that the starting material is spodumene. Thus, detailed descriptions of the grinding and mixing step S12 through the second filtering step S17 are omitted in the present embodiment.

In the present embodiment, sodium hydroxide (NaOH) is used as hydroxide to be mixed with the starting material in the grinding and mixing step S12, and hydrochloric acid is used as an acid solution used in the dissolving step S14.

By carrying out the dissolving step S14, an acid solution is obtained which contains (i) ions of lithium, aluminum, and silicon contained in the spodumene and (ii) sodium chloride (NaCl).

By carrying out the first filtering step S15, it is possible to separate silicic acid (H₂SiO₃) contained in the solid phase.

By carrying out the sodium hydroxide adding step S16 and the second filtering step S17, it is possible to separate aluminum hydroxide (Al(OH)₃) that is contained in the solid phase. In a case where a very small amount of iron (Fe) is present in the starting material, the iron can be separated as iron hydroxide (Fe(OH)₃) contained in the solid phase. Consequently, a sodium hydroxide solution containing lithium hydroxide (LiOH) and sodium chloride (NaCl) is obtained.

The carbon dioxide gas introduction step S91 is identical with the carbon dioxide gas introduction step S81 included in the lithium carbonate production method M80 shown in (b) of FIG. 11. Thus, a description of the carbon dioxide gas introduction step S91 is omitted in the present embodiment. By carrying out the carbon dioxide gas introduction step S91, a liquid phase containing lithium carbonate (Li₂CO₃), sodium chloride, and sodium carbonate (Na₂CO₃) is obtained.

The separating step S92 is a step of separating the sodium carbonate (Na₂CO₃) from the liquid phase containing the lithium carbonate (Li₂CO₃), the sodium chloride, and the sodium carbonate (Na₂CO₃). In the separating step S92, the liquid phase containing the lithium carbonate, the sodium chloride, and the sodium carbonate is concentrated under reduced pressure, and thus a suspension in which the lithium carbonate is dispersed can be obtained. Such a suspension is also called a slurry. Note that the concentration under reduced pressure is preferably carried out at a temperature of not higher than 70° C.

Furthermore, in the separating step S92, centrifugation is carried out on the foregoing suspension. By carrying out the centrifugation, it is possible to precipitate the deposited lithium carbonate. Thus, it is possible to separate the lithium carbonate contained in the solid phase from the sodium chloride and the sodium carbonate contained in the liquid phase.

The drying step S93 is a step identical with that included in the lithium carbonate production method M80 shown in (b) of FIG. 11. In the drying step S93, the lithium carbonate separated in the separating step S92 is dried.

By carrying out the lithium carbonate production method M90 as described above, it is possible to obtain solid lithium carbonate while using spodumene as the starting material.

<Variation of Production Method M90>

In the present embodiment, spodumene is used as the starting material. Note, however, that the starting material used in the production method M90 is not limited to spodumene. Examples of the starting material include oxide minerals (e.g., bauxite), artificial complex oxides (e.g., yttria stabilized zirconia (YSZ) and cordierite), and the like. The bauxite contains aluminum oxide hydrate (Al₂O₃·2H₂O) and aluminum (Al). The YSZ contains zirconia (zirconium oxide, ZrO₂) and yttria (yttrium oxide, Y₂O₃). The cordierite contains magnesium oxide (MgO), aluminum oxide (Al₂O₃), and silicon oxide (SiO₂).

Even in a case where any of those starting materials is used, the production method M90 can be suitably used. As described in the description of the production method M10, the hydroxide to be mixed with the starting material in the grinding and mixing step S12 may be sodium hydroxide or potassium hydroxide. The liquid for dissolving the liquid mixture in the dissolving step S14 may be an acid solution (such as hydrochloric acid, sulfuric acid, or aqua regia), or may be water.

By carrying out a variation of the production method M90 as described above, it is possible to obtain, while using an oxide mineral or a complex oxide as the starting material, a solution (e.g., an aluminum solution) in which an inorganic substance constituting the oxide mineral or the complex oxide is dissolved. In a case where the oxide mineral or the complex oxide contains two or more inorganic substances (e.g., aluminum, noble metal, and the like), it is possible to obtain a solution in which two or more of these inorganic substances are dissolved.

### Embodiment 11

The following description will discuss a method M100 for producing lithium carbonate (Li₂CO₃) in accordance with Embodiment 11 of the present invention with reference to FIG. 13. FIG. 13 shows a flowchart of the production method M100. In the present embodiment, spodumene (LiAlSi₂O₆), which is an example of the lithium ore, is used as the starting material.

As shown in FIG. 13, the production method M100 includes a grinding and mixing step S12, a heating step S13, a dissolving step S14, a first filtering step S15, a sodium hydrogencarbonate adding step S1006, a fifth filtering step S1007, a separating step S1008, and a drying step S1009.

The grinding and mixing step S12 through the first filtering step S15 in the production method M100 are identical with the grinding and mixing step S12 through the first filtering step S15 in the production method M90. Thus, detailed descriptions of the grinding and mixing step S12 through the first filtering step S15 are omitted in the present embodiment.

The sodium hydrogencarbonate adding step S1006 and the fifth filtering step S1007 which are carried out after the first filtering step S15 correspond to the sodium hydroxide adding step S16 and the second filtering step S17 which are included in the production method M90. By carrying out the sodium hydrogencarbonate adding step S1006 and the fifth filtering step S1007, it is possible to separate aluminum hydroxide (Al(OH)₃) that is contained in the solid phase. In a case where a very small amount of iron (Fe) is present in the starting material, the iron can be separated as iron hydroxide (Fe(OH)₃) contained in the solid phase.

Consequently, a sodium hydroxide solution containing lithium carbonate, sodium chloride (NaCl), sodium carbonate (Na₂CO₃), and sodium hydrogencarbonate (NaHCO₃) is obtained.

The separating step S1008 and the drying step S1009 of the production method M100 are steps corresponding to the separating step S92 and the drying step S93 of the production method M90. In the separating step S1008 of the production method M100 also, the sodium hydroxide solution containing the lithium carbonate, the sodium chloride (NaCl), the sodium carbonate (Na₂CO₃), and the sodium hydrogencarbonate (NaHCO₃) is concentrated under reduced pressure and centrifuged, as with the separating step S92 in the production method M90. Consequently, a suspension is obtained in which the lithium carbonate is dispersed. Note that, in the separating step S1008, methanol is added to the sodium hydroxide solution during the concentration under reduced pressure and the centrifugation. This allows the sodium hydrogencarbonate, which is poorly soluble in water as compared to sodium chloride and sodium carbonate, to be dissolved in the liquid phase.

The drying step S1009 is identical with the drying step S93 of the production method M90, and therefore a description thereof is omitted here.

By carrying out the lithium carbonate production method M100 as described above, it is possible to obtain solid lithium carbonate while using spodumene as the starting material.

### Embodiment 12

The following description will discuss a method M110 for producing lithium hydroxide (LiOH) in accordance with Embodiment 12 of the present invention with reference to FIG. 14. FIG. 14 shows a flowchart of the production method M110. In the present embodiment, spodumene (LiAlSi₂O₆), which is an example of the lithium ore, is used as the starting material.

As shown in FIG. 14, the production method M110 includes a grinding and mixing step S12, a heating step S13, a dissolving step S14, a first filtering step S15, a third impurity removing step S1106, a first extracting step S1107, a sulfuric acid adding step S1108, a second extracting step S1109, a calcium hydroxide adding step S1110, a sixth filtering step S1111, a separating step S1112, and a drying step S1113.

The grinding and mixing step S12 and the heating step S13 in the production method M110 are identical with the grinding and mixing step S12 and the heating step S13 in the production method M10. Thus, detailed descriptions of the taking-out step S11 through the heating step S13 are omitted in the present embodiment.

The dissolving step S14 in the production method M110 is identical with the dissolving step S14 in the production method M10, except that an acid solution used is sulfuric acid (H₂SO₄). Thus, a detailed description of the dissolving step S14 is omitted in the present embodiment. By carrying out the dissolving step S14, an acid solution is obtained which contains (i) ions of lithium, aluminum, and silicon contained in the spodumene and (ii) ions of sodium (Na) derived from the sodium hydroxide.

By carrying out the first filtering step S15, it is possible to separate silicic acid (H₂SiO₃) contained in the solid phase.

The third impurity removing step S1106 is a step similar to the first impurity removing step S19 in the production method M10. Note, however, that the third impurity removing step S1106 differs from the first impurity removing step S19 in that, as an organic compound, a mixture of di-(2-ethylhexyl) phosphoric acid (D2EHPA) and tri-n-butyl phosphate (TBP) is used, and sodium hydroxide (NaOH) is further mixed with the above organic substance. By carrying out the third impurity removing step S1106, lithium is adsorbed by D2EHPA and TBP. That is, the lithium is contained in the organic layer. Meanwhile, the aluminum, the silicon, and the sodium are not adsorbed by D2EHPA and TBP and are contained in the water layer.

The first extracting step S1107 is a step of extracting an organic layer from the solution obtained by carrying out the third impurity removing step S1106.

The sulfuric acid adding step S1108 is a step of adding an aqueous solution of sulfuric acid to the organic layer obtained by carrying out the first extracting step S1107. By carrying out the sulfuric acid adding step S1108, lithium having been adsorbed on D2EHPA and TBP forms lithium sulfide (Li₂SO₄), and is transferred from the organic layer to the water layer. Thus, the water layer can also be said an aqueous sulfuric acidic solution containing lithium.

The second extracting step S1109 is a step of extracting a water layer containing lithium sulfide from the solution obtained by carrying out the sulfuric acid adding step S1108.

The calcium hydroxide adding step S1110 is a step of adding calcium hydroxide (Ca(OH)₂) to the water layer (aqueous sulfuric acidic solution containing lithium) obtained by carrying out the second extracting step S1109. By carrying out the calcium hydroxide adding step S1110, the calcium is precipitated by formation of calcium sulfate (CaSO₄), which is sulfate, and lithium is dissolved by ionization with hydroxide ions.

The sixth filtering step S1111 is a step of separating, with use of a filter, a solid phase and a liquid phase contained in the aqueous solution containing lithium obtained through the calcium hydroxide adding step S1110 from each other. The solid phase contains the calcium sulfate. The liquid phase contains the lithium that has been ionized together with the hydroxide ions.

The separating step S1112 and the drying step S1113 of the production method M110 are steps corresponding to the separating step S92 and the drying step S93 of the production method M90. Similarly to the separating step S92, the separating step S1112 carries out concentration under reduced pressure and centrifugation on the solution containing lithium having been ionized with hydroxide ions. By carrying out the separating step S1112, a suspension in which the lithium hydroxide is dispersed is obtained. The drying step S1113 is identical with the drying step S93 of the production method M90, and therefore a description thereof is omitted here.

By carrying out the lithium hydroxide production method M110 as described above, it is possible to obtain solid lithium hydroxide while using spodumene as the starting material.

By carrying out a separating step and a drying step similar to the separating step S1112 and the drying step S1113 on the water layer which contains lithium sulfide and which is obtained by carrying out the second extracting step S1109, it is possible to obtain solid lithium sulfide.

### Embodiment 13

The following description will discuss a method M120 for producing lithium carbonate (Li₂CO₃) in accordance with Embodiment 13 of the present invention with reference to FIG. 15. FIG. 15 shows a flowchart of the production method M120. In the present embodiment, spodumene (LiAlSi₂O₆), which is an example of the lithium ore, is used as the starting material.

As shown in FIG. 15, the production method M120 includes a grinding and mixing step S1202, a heating step S1203, a dissolving step S1204, a first filtering step S1205, a carbon dioxide gas introduction step S1206, a separating step S1208, and a drying step S1209.

The grinding and mixing step S1202 and the heating step S1203 in the production method M120 are identical with the grinding and mixing step S12 and the heating step S13 in the production method M90. Thus, detailed descriptions of the grinding and mixing step S1202 and the heating step S1203 are omitted in the present embodiment.

The dissolving step S1204 is a step of dissolving, in water (H₂O), the liquid mixture which is obtained in the heating step S1203. By carrying out the dissolving step S1204, an aqueous sodium hydroxide solution is obtained in which lithium (Li) and silicon (Si) are dissolved and which contains deposited aluminum hydroxide.

The first filtering step S1205 is a step of separating, with use of a filter, a solid phase and a liquid phase contained in the aqueous sodium hydroxide solution obtained through the dissolving step S1204 from each other. The solid phase contains the aluminum hydroxide. The liquid phase is the aqueous sodium hydroxide solution in which lithium (Li) and silicon (Si) are dissolved.

The carbon dioxide gas introduction step S1206 is a step of introducing a carbon dioxide gas into the aqueous sodium hydroxide solution obtained as a result of separation in the first filtering step S1205. By carrying out the carbon dioxide gas introduction step S1206, the lithium and the sodium form lithium carbonate and sodium carbonate, respectively, which are carbonates. The silicon forms silicic acid ions.

The separating step S1208 and the drying step S1209 of the production method M120 are steps corresponding to the separating step S92 and the drying step S93 of the production method M90. Similarly to the separating step S92, the separating step S1208 also carries out concentration under reduced pressure and centrifugation on the solution containing the lithium carbonate, the sodium carbonate, and the silicic acid ions. By carrying out the separating step S1208, a suspension in which the lithium carbonate is dispersed is obtained. The drying step S1209 is identical with the drying step S93 of the production method M90, and therefore a description thereof is omitted here.

By carrying out the lithium carbonate production method M120 as described above, it is possible to obtain, while using spodumene as the starting material, solid lithium carbonate, even in a case where an acid solution is not used but water is used in the dissolving step S1204.

### Embodiment 14

The following description will discuss a method M130 for producing lithium hydroxide (LiOH) in accordance with Embodiment 14 of the present invention with reference to FIG. 16. FIG. 16 shows a flowchart of the production method M130. In the present embodiment, spodumene (LiAlSi₂O₆), which is an example of the lithium ore, is used as the starting material.

As shown in FIG. 16, the production method M130 includes a grinding and mixing step S1202, a heating step S1203, a dissolving step S1204, a first filtering step S1205, a fourth impurity removing step S1306, a first extracting step S1107, a sulfuric acid adding step S1108, a second extracting step S1109, a calcium hydroxide adding step S1110, a sixth filtering step S1111, a separating step S1112, and a drying step S1113.

The grinding and mixing step S1202 through the first filtering step S1205 in the production method M130 are identical with the grinding and mixing step S1202 through the first filtering step S1205 in the production method M120. Thus, detailed descriptions of the grinding and mixing step S1202 through the first filtering step S1205 are omitted in the present embodiment.

The fourth impurity removing step S1306 is a step similar to the third impurity removing step S1106 in the production method M110. Note, however, that the fourth impurity removing step S1306 differs from the third impurity removing step S1106 in that, as an organic substance, a mixture of thenoyltrifluoroacetone (TTA) and tri-n-butyl phosphate (TBP) is used, and hydrochloric acid (HCl) is further mixed with the above organic matter. By carrying out the fourth impurity removing step S1306, lithium is adsorbed on TTA and TBP. That is, the lithium is contained in the organic layer. Meanwhile, the aluminum, the silicon, and the sodium are not adsorbed by TTA and TBP and are contained in the water layer.

The first extracting step S1107 through the drying step S1113 in the production method M130 are identical with the first extracting step S1107 through the drying step S1113 in the production method M110. Thus, detailed descriptions of the first extracting step S1107 through the drying step S1113 are omitted in the present embodiment.

By carrying out the lithium hydroxide production method M130 as described above, it is possible to obtain, while using spodumene as the starting material, solid lithium hydroxide, even in a case where an acid solution is not used but water is used in the dissolving step S1204.

By carrying out a separating step and a drying step similar to the separating step S1112 and the drying step S1113 on the water layer containing lithium sulfide which is obtained by carrying out the second extracting step S1109, it is possible to obtain solid lithium sulfide.

### Embodiment 15

The following description will discuss a method M140 for producing a nickel compound in accordance with Embodiment 15 of the present invention with reference to FIG. 17. FIG. 17 shows a flowchart of the production method M140. In the present embodiment, nickel sludge is used as the starting material. The nickel sludge is an aspect of metal scrap, and is slag generated in smelting nickel. As such, in the production method M140, metal scrap can be used as the starting material. Note that the nickel sludge contains an element(s) (e.g., fluorine (F) and sulfur (S)) other than nickel (Ni). Thus, nickel sludge is an example of a nickel compound. Note, however, that the starting material used in the production method M140 is not limited to the nickel sludge. The starting material may be a metal generated in a production step or a processing step of a machine, an electronic component, or the like, or may be a compound containing such a metal.

In the production method M140, the nickel contained in the nickel sludge is not dissolved in a solution (i.e., an acid solution or water that is a solvent), but an element(s) other than the nickel is dissolved in the solution. By dissolving the element(s) other than the nickel in the solution, it is possible to enhance the purity of the nickel remaining as a solid. Thus, the production method M140 can also be said a method for purifying a nickel compound.

As shown in FIG. 17, the production method M140 includes a grinding and mixing step S1402, a heating step S1403, a dissolving step S1404, and a first filtering step S1405.

The grinding and mixing step S1402 is a step corresponding to the grinding and mixing step S12 in the production method M10. That is, the grinding and mixing step S1402 is a step of grinding the starting material and mixing the ground starting material with powder of the hydroxide. In the present embodiment, sodium hydroxide (NaOH) is used as hydroxide. Note, however, that the hydroxide is not limited to sodium hydroxide, and may be potassium hydroxide (KOH). As such, the grinding and mixing step S1402 is identical with the grinding and mixing step S12, except that the starting material is nickel sludge. Thus, a detailed description of the grinding and mixing step S1402 is omitted in the present embodiment.

The heating step S1403, the dissolving step S1404, and the first filtering step S1405 are similar to the heating step S13, the dissolving step S14, and the first filtering step S15, respectively, in the production method M10. Thus, detailed descriptions of the heating step S1403, the dissolving step S1404, and the first filtering step S1405 are omitted in the present embodiment.

In the dissolving step S1404, water is used as a liquid for dissolving the liquid mixture obtained in the heating step S1403. In the present embodiment, the sodium hydroxide contained in the liquid mixture is dissolved in water. Therefore, the solution obtained as a result of the dissolving step S1404 is an aqueous sodium hydroxide solution containing the starting material. By carrying out the dissolving step S1404, fluorine and sulfur contained in the nickel sludge are dissolved in the sodium hydroxide.

By carrying out the first filtering step S1405, the nickel sludge constituting the solid phase is separated from the sodium hydroxide solution containing fluorine and sulfur contained in the liquid phase. By collecting the solid phase, it is possible to obtain nickel sludge in which the concentration of impurities such as fluorine and sulfur is reduced as compared to that in the starting material.

As described above, by carrying out the nickel compound production method M140, it is possible to purify nickel sludge.

The production method M140 can also be carried out again on the solid phase (i.e., nickel sludge purified once) obtained by carrying out the first filtering step S1405. By repeating the production method M140 twice or more times, it is possible to increase the purity of nickel in the obtained nickel sludge.

### Embodiment 16

With reference to FIG. 18, the following will discuss an iron separation method M150 in accordance with Embodiment 16 of the present invention. FIG. 18 shows a flowchart of the separation method M150. In the present embodiment, ferberite (FeWO₄) is used as the starting material. The ferberite is an example of the tungstate mineral.

As shown in FIG. 18, the separation method M150 includes a grinding and mixing step S1502, a heating step S1503, a dissolving step S1504, a first filtering step S1505, a hydrochloric acid immersing step S1552, and a third filtering step S1553.

The grinding and mixing step S1502 is a step corresponding to the grinding and mixing step S12 in the production method M10. That is, the grinding and mixing step S1502 is a step of grinding the starting material and mixing the ground starting material with powder of the hydroxide. In the present embodiment also, the form of the sodium hydroxide is not limited to powder. In the present embodiment, sodium hydroxide (NaOH) is used as hydroxide. As such, the grinding and mixing step S1502 is identical with the grinding and mixing step S12, except that the starting material is ferberite. Thus, a detailed description of the grinding and mixing step S1502 is omitted in the present embodiment.

The heating step S1503, the dissolving step S1504, and the first filtering step S1505 are similar to the heating step S13, the dissolving step S14, and the first filtering step S15, respectively, in the production method M10. Thus, detailed descriptions of the heating step S1503, the dissolving step S1504, and the first filtering step S1505 are omitted in the present embodiment.

In the dissolving step S1504, water is used as a liquid for dissolving the liquid mixture obtained in the heating step S1503. Note, however, that the liquid used in the dissolving step S1504 is not limited to water, and may be an acid solution (e.g., a hydrochloric acidic solution and a sulfuric acidic solution). In the present embodiment, the sodium hydroxide contained in the liquid mixture is dissolved in water. Therefore, the solution obtained as a result of the dissolving step S1504 is an aqueous sodium hydroxide solution containing the starting material. By carrying out the dissolving step S1504, a most part (e.g., not less than 90%) of tungsten (W) contained in the ferberite is dissolved in the sodium hydroxide. Thus, the solid phase contains iron oxide generated as a result of elution of the tungsten from the ferberite.

By carrying out the first filtering step S1505, iron oxide constituting the solid phase is obtained.

The hydrochloric acid immersing step S1552 and the third filtering step S1553 are similar to the hydrochloric acid immersing step S52 and the third filtering step S53, respectively, in the method M50 for separating titanium and lithium from each other. Thus, detailed descriptions of the hydrochloric acid immersing step S1552 and the third filtering step S1553 are omitted in the present embodiment.

By carrying out the hydrochloric acid immersing step S1552, iron contained in the iron oxide is dissolved in the hydrochloric acidic solution as iron chloride. Thus, the hydrochloric acidic solution that has undergone the hydrochloric acid immersing step S1552 contains the iron chloride contained in the liquid phase.

As described above, by carrying out the iron separation method M150, it is possible to separate tungsten and iron contained in the ferberite.

In the dissolving step S1504, it is possible to use an acid solution (e.g., a hydrochloric acidic solution) as a liquid for dissolving the liquid mixture obtained in the heating step S1503. In this case, iron contained in the ferberite is dissolved in the hydrochloric acidic solution, and tungsten contained in the ferberite remains in the solid phase. As such, merely by using an acid solution in the dissolving step S1504, it is possible to obtain an acid solution in which iron is dissolved.

### Example Group

The following description will discuss an Example group of the present invention. In Example 1 and Example 2 described above, beryl and spodumene were respectively used as the starting materials. In the following Example group, silicon oxide, nickel sludge, ferberite, monazite, apatite, xenotime, bauxite, magnetite, iron ore, rutile, and sphalerite, were used as the starting material. In Example in which spodumene was used as the starting material, water was used as the liquid for dissolving the mixture in the dissolving step S14. The results in Examples are indicated in Table 1. Note that Table 1 also includes the results of Examples 1 and 2.

TABLE 1

| | Dissolving | Dissolving | Separation |
|---|---|---|---|
| | step | step | method |
| Starting material | (acid solution) | (water) | M150 |
| Silicon oxide | Δ | ∘ | |
| | Precipitated as | (>90%) | |
| | silicic acid | | |
| Aluminum oxide | ∘ | ∘ | |
| | (>90%) | (>90%) | |
| Titanium oxide | ∘ | | |
| | (>90%) | | |
| Beryllium oxide | ∘ | ∘ | |
| | (approximately 90%) | (>70%) | |
| Lithium titanate | ∘ | x | |
| | (>90%) | | |
| Beryl | ∘ | ∘ | |
| | (>90%) | (>50%) | |
| Spodumene | ∘ | ∘ | |
| | (>90%) | (>90%) | |
| Monazite | ∘ | | |
| | (50%) | | |
| Apatite | ∘ | | |
| | (>90%) | | |
| Xenotime | ∘ | | |
| | (50%) | | |
| Magnetite | ∘ | x | |
| | (>90%) | | |
| Iron ore | ∘ | x | |
| | (>90%) | | |
| Molybdenite | ∘ | | |
| | (>60%) | | |
| Sphalerite | ∘ | ∘ | |
| | (>90%) | (>80%) | |
| Ferberite | ∘ | ∘ | ∘ |
| | (Fe > 90%) | (W > 90%) | (Fe&W > 90%) |
| Cobalt-rich crust | ∘ | | |
| | (>90%) | | |
| Manganese | ∘ | x | |
| nodule | (approximately 85%) | | |
| Nickel sludge | | ∘ | |

In Table 1, the symbol of hollow circle indicates that at least a part of a target element to be dissolved among elements contained in the starting material was dissolved, and the symbol of cross indicates that the target element to be dissolved was not dissolved.

### Example 3

In Example 3, in the production method M90 shown in FIG. 12, the grinding and mixing step S12 through the dissolving step S14 were carried out. In this Example, a highly pure reagent of silicon oxide (SiO₂) was used as the starting material. In this Example, sodium hydroxide was used as hydroxide to be mixed in the grinding and mixing step S12.

In this Example, the weight ratio of the silicon oxide and the sodium hydroxide to be mixed in the grinding and mixing step S12 was set to 1:10. In the heating step S13, dielectrical heating was carried out with the dielectric heating device 10 in the air atmosphere under normal pressure. The heating temperature in the heating step S13 was set to 300° C., and the heating time was set to 8 minutes. By carrying out the heating step S13, the powdery mixture was fused through the dielectric heating, and the powdery mixture entirely became a liquid mixture in the form of emulsion after 8 minutes. Hereinafter, when it is not necessary to distinguish whether the mixture is in the form of powder or liquid, the mixture is referred to simply as a mixture. Moreover, this Example included cases where, as the liquid for dissolving the mixture in the dissolving step S14, a hydrochloric acidic solution was used and water was used.

In a case where the hydrochloric acidic solution was used as the liquid for dissolving the mixture, precipitation of silicic acid (H₂SiO₄) occurred. It seems that the silicic acid was generated through two reactions from the silicon oxide that is the starting material. The first reaction is a reaction in which the silicon oxide and the sodium hydroxide react with each other so that sodium silicate (Na₂SiO₄) is generated. Since the sodium silicate is water-soluble, the sodium silicate is dissolved in a solution. As the second reaction, the sodium silicate and hydrochloric acid react with each other to generate silicic acid. Since the silicic acid is insoluble, the silicic acid was precipitated in the solution. The fact that the above-described two reactions occurred when the hydrochloric acidic solution was used as the liquid for dissolving the mixture was confirmed also from the fact that no precipitation occurred when water was used instead of the hydrochloric acid. Therefore, in Table 1, the symbol of hollow triangle indicates the case in which silicon oxide was used as the starting material and the hydrochloric acidic solution was used as the liquid for dissolving the mixture.

In a case where water was used as the liquid for dissolving the mixture, it seems that silicon was dissolved in the solution in the state of sodium silicate having water solubility. In this case, the solubility of the silicon oxide was not less than 90%.

As described above, in this Example, the silicon oxide was used as the starting material. In a glass material (e.g., quartz glass) and silica stone, the main component is also silicon oxide. Therefore, the result of Example 3 applies also to a glass material (e.g., quartz glass) and silica stone.

### Example Group 4

In Example group 4, in the production method M90 shown in FIG. 12, the grinding and mixing step S12 through the dissolving step S14 were carried out, as with Example 3. In this Example group, a reagent of aluminum oxide (Al₂O₃) was used as the starting material. In this Example group, aluminum oxide was employed as the starting material, as a simulation of bauxite. In this Example group, sodium hydroxide was used as hydroxide to be mixed in the grinding and mixing step S12. Moreover, this Example group included cases where, as the liquid for dissolving the mixture in the dissolving step S14, a hydrochloric acidic solution was used and water was used.

After the dissolving step S14 was carried out, white-turbid solutions were obtained in both cases where the hydrochloric acidic solution was used and water was used as the liquid for dissolving the mixture. As a result of analyzing the white-turbid solutions, it has been found that the aluminum oxide is soluble in both the aqueous hydrochloric acidic solution and the water. The solubility of the aluminum in the aqueous hydrochloric acidic solution was 99%. The solubility of the aluminum in the water was 95%.

### Example Group 5

In Example group 5, in the production method M90 shown in FIG. 12, the grinding and mixing step S12 through the dissolving step S14 were carried out, as with Example 3. In this Example group, a reagent of titanium oxide (TiO₂) was used as the starting material. In this Example group, (1) sodium hydroxide and a hydrochloric acidic solution, (2) sodium hydroxide and a sulfuric acidic solution, and (3) potassium hydroxide and a sulfuric acidic solution were each employed as a combination of hydroxide to be mixed in the grinding and mixing step S12 and a liquid for dissolving the mixture in the dissolving step S14.

After the dissolving step S14 was carried out, white-turbid solutions each containing a residue were obtained in all of the above-described cases (1), (2), and (3). As a result of analyzing the obtained residue, it has been found that the titanium oxide is soluble in the acid solution. The solubilities of the titanium in the combinations (1), (2), and (3) were 25%, 50%, and 98%, respectively. The row of titanium oxide in Table 1 indicates the case of (3).

### Example Group 6

In Example group 6, in the production method M10 shown in FIG. 1, the grinding and mixing step S12 through the dissolving step S14 were carried out. In this Example group, a reagent of beryllium oxide (BeO) was used as the starting material. In this Example group, beryllium oxide was employed as the starting material, as a simulation of beryllium oxide formed on a surface of beryllium, which is an example of the neutron multiplying material. This is because it is known that beryllium is easily dissolved in an acid solution, and beryllium oxide is formed on the surface of used beryllium as a neutron multiplying material.

In this Example group, sodium hydroxide was used as hydroxide to be mixed in the grinding and mixing step S12. Moreover, this Example group included cases where, as the liquid for dissolving the mixture in the dissolving step S14, a hydrochloric acidic solution was used and water was used.

After the dissolving step S14 was carried out, white-turbid solutions each containing a residue were obtained in both cases where the hydrochloric acidic solution was used and water was used as the liquid for dissolving the mixture. As a result of analyzing the obtained residues, it has been found that the beryllium oxide is soluble in both the aqueous hydrochloric acidic solution and the water. The solubility of beryllium in the aqueous hydrochloric acidic solution was 90%. The solubility of beryllium in water was 77%.

### Example Group 7

In Example group 7, in the production method M10 shown in FIG. 1, the grinding and mixing step S12 through the dissolving step S14 were carried out. In this Example group, a reagent of lithium titanate (Li₂TiO₃) was used as the starting material. The lithium titanate is an example of the tritium breeder material. In this Example group, sodium hydroxide was used as hydroxide to be mixed in the grinding and mixing step S12. Moreover, this Example group included cases where, as the liquid for dissolving the mixture in the dissolving step S14, a sulfuric acidic solution was used and water was used.

After the dissolving step S14 was carried out, white-turbid solutions each containing a residue were obtained in both cases where the sulfuric acidic solution was used and water was used as the liquid for dissolving the mixture. As a result of analyzing the obtained residues, it has been found that the lithium titanate is soluble in both the aqueous sulfuric acidic solution and the water. The solubility of the lithium in the aqueous sulfuric acidic solution was 97%. The solubility of the lithium in the water was 19%.

### Examples 1, 2, and 8

As described in Example 1, beryl was completely dissolved in the aqueous hydrochloric acidic solution (99% dissolution of beryllium was confirmed). As described in Example 2, spodumene was dissolved in the aqueous hydrochloric acidic solution (90% or higher dissolution of lithium was confirmed). As a variation of Example 1, the liquid for dissolving the liquid mixture in the dissolving step S14 was changed from the aqueous hydrochloric acidic solution to water. In this case, the solubility of beryllium contained in the beryl was 56%.

As Example 8, spodumene was used as the starting material as with Example 2, and water was used as the liquid for dissolving the mixture. As a result, the spodumene was dissolved in the water (96% dissolution of lithium was confirmed).

### Example 9

In Example 9, in the production method M90 shown in FIG. 12, the grinding and mixing step S12 through the dissolving step S14 were carried out, as with Example 3. In this Example, monazite ((Ce, La, Nd, Th)PO₄) was used as the starting material. In this Example, sodium hydroxide was used as hydroxide to be mixed in the grinding and mixing step S12. In this Example, the heating temperature in the heating step S13 was set to 250° C. Moreover, in this Example, a hydrochloric acidic solution was used as the liquid for dissolving the mixture in the dissolving step S14.

After the dissolving step S14 was carried out, a yellow-turbid solution was obtained. The result of analyzing this solution is shown in FIG. 19. FIG. 19 is a graph showing solubilities of yttrium (Y), lanthanum (La), cerium (Ce), neodymium (Nd), samarium (Sm), terbium (Tb), and dysprosium (Dy) contained in monazite. According to FIG. 19, the yttrium exhibited a solubility of approximately 80%. Each of the lanthanum, the neodymium, the samarium, the terbium, and the dysprosium exhibited a solubility of not less than 50% and not more than 65%. The cerium exhibited a solubility of approximately 20%.

### Example 10

In Example 10, in the production method M90 shown in FIG. 12, the grinding and mixing step S12 through the dissolving step S14 were carried out, as with Example 3. In this Example, apatite (Ce₅(PO₄)₃(F, Cl, OH)₁) was used as the starting material. In this Example, sodium hydroxide was used as hydroxide to be mixed in the grinding and mixing step S12. In this Example, the heating temperature in the heating step S13 was set to 250° C. Moreover, in this Example, a hydrochloric acidic solution was used as the liquid for dissolving the mixture in the dissolving step S14.

After the dissolving step S14 was carried out, a solution with little residue was obtained. As a result of analyzing this solution, the solubility of the apatite was not less than 90%.

### Example 11

In Example 11, in the production method M90 shown in FIG. 12, the grinding and mixing step S12 through the dissolving step S14 were carried out, as with Example 3. In this Example, xenotime (YPO₄) was used as the starting material. In this Example, sodium hydroxide was used as hydroxide to be mixed in the grinding and mixing step S12. In this Example, the heating temperature in the heating step S13 was set to 250° C. Moreover, in this Example, a hydrochloric acidic solution was used as the liquid for dissolving the mixture in the dissolving step S14.

After the dissolving step S14 was carried out, the solubility of xenotime was approximately 50%.

### Examples 12 and 13

In Examples 12 and 13, in the production method M90 shown in FIG. 12, the grinding and mixing step S12 through the dissolving step S14 were carried out, as with Example 3. In Examples 12 and 13, magnetite (Fe₃O₄) and an iron ore (Fe₂O₃) were used, respectively, as the starting material. In this Example, sodium hydroxide was used as hydroxide to be mixed in the grinding and mixing step S12. In this Example, the heating temperature in the heating step S13 was set to 250° C. Moreover, in this Example, a hydrochloric acidic solution was used as the liquid for dissolving the mixture in the dissolving step S14.

After the dissolving step S14 was carried out, the residue obtained was analyzed. As a result, the solubility of the magnetite was not less than 90%, and the solubility of the iron ore was also not less than 90%. In addition, the step was carried out with use of magnetite as the starting material and with use of water as the liquid for dissolving the mixture. As a result, the magnetite and the iron ore were not dissolved.

### Example 14

In Example 14, in the production method M90 shown in FIG. 12, the grinding and mixing step S12 through the dissolving step S14 were carried out, as with Example 3. In this Example, molybdenite (MoS₂) was used as the starting material. In this Example, sodium hydroxide was used as hydroxide to be mixed in the grinding and mixing step S12. In this Example, the heating temperature in the heating step S13 was set to 250° C. Moreover, in this Example, as the liquid for dissolving the mixture in the dissolving step S14, (1) a hydrochloric acidic solution, (2) a 2 M nitric acidic solution, (3) a mixture solution of sulfuric acid and nitric acid, and (4) a 5 M nitric acidic solution were used.

After the dissolving step S14 was carried out, the residues obtained were analyzed. As a result, the solubilities of molybdenum were 25%, 44%, 62%, and 65%, respectively, for (1) to (4). In the row of molybdenite in Table 1, the cases of (3) and (4) are indicated.

### Example Group 15

In Example group 15, in the production method M90 shown in FIG. 12, the grinding and mixing step S12 through the dissolving step S14 were carried out, as with Example 3. In this Example group, sphalerite ((Zn, Fe)S) was used as the starting material. In this Example group, sodium hydroxide was used as hydroxide to be mixed in the grinding and mixing step S12. Moreover, this Example group included cases where, as the liquid for dissolving the mixture in the dissolving step S14, a hydrochloric acidic solution was used and water was used.

After the dissolving step S14 was carried out, turbid solutions each containing a residue were obtained in both cases where the hydrochloric acidic solution was used and water was used as the liquid for dissolving the mixture. As a result of analyzing the obtained residues, it has been found that the sphalerite is soluble in both the aqueous hydrochloric acidic solution and the water. The solubility of the sphalerite in the aqueous hydrochloric acidic solution was not less than 90%. The solubility of the aluminum in the water was not less than 80%.

### Examples 16 and 17

In Example 16, in the production method M90 shown in FIG. 12, the grinding and mixing step S12 through the dissolving step S14 were carried out, as with Example 3. In this Example group, ferberite (FeWO₄) was used as the starting material. In this Example group, sodium hydroxide was used as hydroxide to be mixed in the grinding and mixing step S12. Moreover, in this Example group, a hydrochloric acidic solution was used as the liquid for dissolving the mixture in the dissolving step S14.

In Example 17, the separation method M150 shown in FIG. 18 was carried out. In this Example, ferberite (FeWO₄) was used as the starting material. In this Example group, sodium hydroxide was used as hydroxide to be mixed in the grinding and mixing step S12. Moreover, in this Example group, water was used as the liquid for dissolving the mixture in the dissolving step S14.

In Example 16, a turbid solution containing a residue was obtained after the dissolving step S14 was carried out. As a result of analyzing the obtained residue, it has been found that the solubility of iron contained in the ferberite was not less than 90%. Note, however, that, in this turbid solution, a compound containing tungsten was precipitated as a residue.

In Example 17, a turbid solution containing a residue was obtained after the dissolving step S1504 was carried out. As a result of analyzing the obtained residue, it has been found that the solubility of tungsten contained in the ferberite was not less than 90%. Note, however, that, in this turbid solution, a compound containing iron was precipitated as the residue. Next, the hydrochloric acid immersing step S1552 and the third filtering step S1553 were carried out, and consequently a clear solution was obtained. As a result of analyzing this solution, it has been found that the solubility of iron contained in the ferberite was not less than 90%.

### Example 18

In Example 18, in the production method M90 shown in FIG. 12, the grinding and mixing step S12 through the dissolving step S14 were carried out, as with Example 3. In this Example group, a cobalt-rich crust was used as the starting material. In this Example group, potassium hydroxide was used as hydroxide to be mixed in the grinding and mixing step S12. Moreover, in this Example group, a hydrochloric acidic solution was used as the liquid for dissolving the mixture in the dissolving step S14.

In Example 18, a solution containing a slight residue was obtained after the dissolving step S14 was carried out. As a result of analyzing the residue, it has been found that the solubility of the cobalt-rich crust was approximately 95%.

### Example Group 19

In Example group 19, in the production method M90 shown in FIG. 12, the grinding and mixing step S12 through the dissolving step S14 were carried out, as with Example 3. In this Example group, a manganese nodule was used as the starting material. In this Example group, sodium hydroxide and potassium hydroxide were each used as hydroxide to be mixed in the grinding and mixing step S12. In this Example group, the heating temperature in the heating step S13 was set to 250° C. Moreover, in this Example group, hydrochloric acid and water were each used as the liquid for dissolving the mixture in the dissolving step S14. As combinations of hydroxide and the liquid, (1) sodium hydroxide and a hydrochloric acidic solution, (2) sodium hydroxide and water, and (3) potassium hydroxide and a hydrochloric acidic solution were employed. In the row of the manganese nodule in Table 1, the cases of (2) and (3) are indicated.

After the dissolving step S14 was carried out, a solution containing a residue was obtained in all of the above-described cases (1), (2), and (3). As a result of analyzing the residues for (1), (2), and (3), the solubilities of the manganese nodule were approximately 56%, approximately 27%, and approximately 85%, respectively.

### Example Group 20

In Example group 20, the production method M140 shown in FIG. 17 was carried out. In this Example group, nickel sludge was used as the starting material. In this Example group, sodium hydroxide and potassium hydroxide were each used as hydroxide to be mixed in the grinding and mixing step S12. Moreover, in this Example group, water was used as the liquid for dissolving the mixture in the dissolving step S14. In Example group 20, after the production method M140 was carried out, the obtained solid phase was subjected to the production method M140 again.

In a case where sodium hydroxide was used as hydroxide, a yellowish solution containing a residue was obtained after the first dissolving step S1404 was carried out. As a result of analyzing the yellowish solution, the concentration of fluorine ions was 16.7%, and the concentration of sulfur ions was 3.4%. No nickel was detected. As a result of analyzing a solution obtained after the second dissolving step S1404 was carried out, the concentration of fluorine ions was 0.5%, and the concentration of sulfur ions was 0.3%.

In a case where potassium hydroxide was used as hydroxide, a yellowish solution containing a residue was obtained after the first dissolving step S1404 was carried out. As a result of analyzing the yellowish solution, the concentration of fluorine ions was 15.8%, and the concentration of sulfur ions was 3.3%. No nickel was detected. As a result of analyzing a solution obtained after the second dissolving step S1404 was carried out, the concentration of fluorine ions was 0.5%, and the concentration of sulfur ions was less than the detection limit.

As described above, it has been found that, by carrying out the production method M140, it is possible to cause, in the solution, elution of fluorine ions and sulfur ions contained in the nickel sludge that is the starting material, and this makes it possible to increase the purity of nickel contained in the nickel sludge.

Aspects of the present invention can also be expressed as follows:

A method for producing an inorganic substance solution in accordance with aspect 1 of the present invention includes: a heating step of dielectrically heating a powdery mixture to obtain a liquid mixture containing an inorganic substance, the powdery mixture having been obtained by mixing powder of the inorganic substance and hydroxide. In this production method, the form of the hydroxide is not limited.

A hydroxyl group contained in hydroxide absorbs an electromagnetic wave used for dielectric heating, and consequently converts energy of the electromagnetic wave into its own thermal energy. In the heating step of this production method, the powder of the inorganic substance and the powder of the hydroxide are mixed together. Therefore, thermal energy of the hydroxide is efficiently supplied also to the inorganic substance. As a result, it is possible to obtain a liquid mixture in which the inorganic substance and the hydroxide are fused. This liquid mixture is easily dissolved in an acid solution. Therefore, by using this liquid mixture, it is possible to produce an inorganic substance solution.

In the heating step, it is not necessary to carry out a high temperature (e.g., 770° C., 1650° C., 2000° C.) treatment, unlike the sintering treatment or the melting treatment disclosed in Non-patent Literature 1. That is, in the heating step, it is possible to obtain a liquid mixture merely by carrying out dielectric heating on a powdery mixture. Thus, the present production method achieves higher energy efficiency, as compared to the production method disclosed in Non-patent Literature 1.

As described above, this production method can be provided as a method for producing a solution of an inorganic substance (e.g., a beryllium ore) that is poorly soluble in both a basic solution and an acidic solution, the method being novel and having high energy efficiency.

The method in accordance with aspect 2 of the present invention employs, in addition to the feature of aspect 1 above, a feature in which: the inorganic substance contains at least one of beryllium and lithium.

An example of the inorganic substance may be a substance containing at least one of beryllium and lithium.

The method in accordance with aspect 3 of the present invention employs, in addition to the feature of aspect 1 or 2 above, a feature in which: the hydroxide is at least one of sodium hydroxide and potassium hydroxide.

As such, examples of the hydroxide encompass sodium hydroxide and potassium hydroxide. As the hydroxide, it is possible to use a mixture of sodium hydroxide and potassium hydroxide.

The method in accordance with aspect 4 of the present invention employs, in addition to the feature of any one of aspects 1 to 3 above, a feature of further including: a dissolving step of dissolving the liquid mixture which has been obtained in the heating step in an acid solution or water to obtain an acid solution of the inorganic substance.

With the above configuration, it is possible to reliably obtain an inorganic substance solution.

The method in accordance with aspect 5 of the present invention employs, in addition to the feature of any one of aspects 1 to 4 above, a feature in which: the heating step is a step of dielectrically heating the powdery mixture under normal pressure.

As such, in the heating step of this production method, it is possible to obtain a liquid mixture without pressurizing the powdery mixture during dielectric heating. Thus, it is possible to easily construct a production device for carrying out this production method, and it is possible to reduce the labor for obtaining permission of a plant in which the production device is to be installed.

A device for producing an inorganic substance solution in accordance with aspect 6 of the present invention includes: a mixing section that mixes powder of an inorganic substance with hydroxide to obtain a powdery mixture of the inorganic substance and the hydroxide; a container that accommodates the powdery mixture; and an electromagnetic wave generator that generates an electromagnetic wave for dielectric heating.

The above configuration brings about similar effects to those given by the inorganic substance solution production method in accordance with aspect 1 above. The form of the hydroxide to be mixed with the powder of the inorganic substance in the mixing section of the production device is not limited.

The device in accordance with aspect 7 of the present invention employs, in addition to the feature of aspect 6 above, a feature in which: the inorganic substance contains at least one of beryllium and lithium.

The above configuration brings about similar effects to those given by the inorganic substance solution production method in accordance with aspect 2 above.

The device in accordance with aspect 8 of the present invention employs, in addition to the feature of aspect 6 or 7 above, a feature in which: the hydroxide is at least one of sodium hydroxide and potassium hydroxide.

The above configuration brings about similar effects to those given by the inorganic substance solution production method in accordance with aspect 3 above. As the hydroxide, it is possible to use a mixture of sodium hydroxide and potassium hydroxide.

The device in accordance with aspect 9 of the present invention employs, in addition to the feature of any one of aspects 6 to 8 above, a feature of further including: a waveguide that is provided between the electromagnetic wave generator and the container and that guides the electromagnetic wave from the electromagnetic wave generator to the container; and an isolator that is provided midway along the waveguide and that absorbs an electromagnetic wave propagating from the container to the electromagnetic wave generator.

With the above configuration, even in a case where a part of the electromagnetic wave generated by the electromagnetic wave generator is turned back from the container to the direction toward the electromagnetic wave generator, the isolator can absorb such an electromagnetic wave. This makes it possible to reduce a case where such an electromagnetic wave adversely affects the operation of the electromagnetic wave generator.

The device in accordance with aspect 10 of the present invention employs, in addition to the feature of any one of aspects 6 to 9 above, a feature of further including: a liquid supplying section that supplies an acid solution or water to the container.

The above configuration brings about similar effects to those given by the inorganic substance solution production method in accordance with aspect 4 above.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

M10: Production method (method for producing inorganic substance solution)
S13: Heating step
S14: Dissolving step
10, 22: Dielectric heating device (device for producing inorganic substance solution)
11, 22a: Electromagnetic wave generator
12, 22b: Waveguide
14, 22c: Container
18: Isolator

1. A method for producing an inorganic substance solution, said method comprising:
a heating step of dielectrically heating a powdery mixture to obtain a liquid mixture containing an inorganic substance, the powdery mixture having been obtained by mixing powder of the inorganic substance and hydroxide.

2. The method as set forth in claim 1, wherein:
the inorganic substance contains at least one of beryllium and lithium.

3. The method as set forth in claim 1, wherein:
the hydroxide is at least one of sodium hydroxide and potassium hydroxide.

4. The method as set forth in claim 1, further comprising:
a dissolving step of dissolving the liquid mixture which has been obtained in the heating step in an acid solution or water to obtain an acid solution of the inorganic substance.

5. The method as set forth in claim 1, am wherein:
the heating step is a step of dielectrically heating the powdery mixture under normal pressure.

6. A device for producing an inorganic substance solution, said device comprising:
a mixing section that mixes powder of an inorganic substance with hydroxide to obtain a powdery mixture of the inorganic substance and the hydroxide;
a container that accommodates the powdery mixture; and
an electromagnetic wave generator that generates an electromagnetic wave for dielectric heating.

7. The device as set forth in claim 6, wherein:
the inorganic substance contains at least one of beryllium and lithium.

8. The device as set forth in claim 6, wherein:
the hydroxide is at least one of sodium hydroxide and potassium hydroxide.

9. The device as set forth in claim 6, further comprising:
a waveguide that is provided between the electromagnetic wave generator and the container and that guides the electromagnetic wave from the electromagnetic wave generator to the container; and
an isolator that is provided midway along the waveguide and that absorbs an electromagnetic wave propagating from the container to the electromagnetic wave generator.

10. The device as set forth in claim 6, further comprising:
a liquid supplying section that supplies an acid solution or water to the container.
